(19) United States
(12) Patent Application Publication
(10) Pub. No.: US 2005/0064209 A1
(43) Pub. Date: Mar. 24, 2005

(54) Low-fluorescent, chemically durable hydrophobic patterned substrates for the attachment of biomolecules

(76) Inventors: Daniel Haines, Moscow, PA (US); Christina Knoedler, Mountaintop, PA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/778,332

(22) Filed: Feb. 17, 2004

(51) Int. Cl. B32B 5/16; B32B 9/04; B05D 5/12

(52) U.S. Cl. 428/447; 428/323; 428/426; 428/331; 428/442; 428/448

(57) ABSTRACT

The invention relates to hydrophobic patterned, low self-fluorescent substrates for attaching biomolecules and a method of making them. The patterned material will not interfere with end use assay analysis because the patterning composition is manufactured so to have very low self-fluorescence in the spectral regions typically used for microarraying applications. Further, the patterning compositions are chemically and physically durable and will not be deleteriously affected by typical chemical or physical processes utilized for cleaning, coating or assaying processes. In a preferred embodiment, the patterned silicone composition is applied to the substrate by screen-printing.

In a typical microarray experiment, biologically relevant probes are immobilized on a coated substrate in an arrayed format, containing anywhere from tens to tens of thousands of probes per cm², enabling the detection of biologically relevant targets in a multiplexed manner. Microarray technology has proven to be an indispensable functional investigative genomic tool, as most common diseases such as cancer, heart disease, and diabetes are thought to be multi-genetic diseases—meaning more than one gene is involved in the disease process. Microarray experiments can be performed to rapidly identify genes that may be up or down-regulated in a particular disease. High-density microarray screening experiments allow scientists to quickly focus on and further investigate a lower number of specific genes that can be used as diagnostic markers or considered as the basis for a drug discovery target. Microarrays can also be used to detect single nucleotide polymorphisms (SNP), a one base-pair change relative to the normal gene sequence. The ability to characterize and correlate an individual's genetic variants with disease susceptibility and responsiveness to therapeutic agents, is necessary in the broad realization of individualized and population based medical assays.

Once specific markers have been identified, microarrays can be used for parallel processing of large sample sets. One useful format is a surface partitioned substrate that has “wells” (areas for conducting the analyses) and “boundary” (areas between the wells that are designed to aid in probe/target location registration and prevention of cross contamination between wells) regions. Polytetrafluoro-ethylene (PTFE) based patterning compositions are often used to form hydrophobic boundary regions on a substrate, providing separation between the individual hydrophilic wells. Each well can be used for single or multiple arrays of probes, forming an “array of arrays”—a composite array comprising a plurality of individual arrays. The patterning composition can be applied in various well densities to allow processing of multiple assays in parallel rather than serially, thus providing decreased cost, reduced amplification requirements, and improved reproducibility to the microarray user, without the worry of cross contamination between arrays.

Commercially available hydrophobic-patterned substrates are typically prepared by application of a PTFE polymer or copolymer, or related fluoropolymer based resin mixtures onto a glass substrate and subsequently curing to form a stable coating. PTFE patterning materials exhibit excellent hydrophobicity (H₂O contact angles >140°), yet are hindered by poor chemical durability and/or physical degradation during glass cleaning, coating, and/or assaying processes. PTFE based formulations are susceptible to chemical attack by strong base solutions and physical degradation by ultrasonication, which are often crucial components in effective glass cleaning protocols. Additionally, PTFE hydrophobic patterns exhibit poor coating uniformity with regards to uneven surface coverage (e.g., unintended holes or areas in the pattern where the patterning material is scant or non-existent) and thickness uniformity. Poor coating uniformity leads to irregular and non-smooth well-to-pattern transition areas. Lack of pattern uniformity may further interfere with coverslip or gasketing placement and sealing integrity in probe/target interaction (assaying) processes. Well contamination by PTFE patterning materials and the inability to thoroughly clean wells for subsequent coating without removing and/or weakening the pattern are also undesirable characteristics of the PTFE materials. Furthermore, the high intrinsic fluorescence of the PTFE patterning material creates end use problems for researchers who use fluorescent detection technologies to assess the outcome of their DNA, carbohydrate, or protein microarray experiments. It is desirable to minimize any fluorescence coming from the patterned substrate.

The invention relates to a surface for attachment of molecules comprising a substrate and a patterned hydrophobic crosslinked silicone containing coating on said substrate. The substrate may further contain a coating of a chemically functional compound to which other molecules are chemically bondable. Preferably the substrate and the hydrophobic silicone-containing coating are low self-fluorescent.

The invention also relates to a method of preparing a hydrophobic patterned substrate useful for the attachment of biomolecules comprising applying to a substrate a pattern of a silicone containing composition, said composition comprising a crosslinkable silicone, a crosslinking agent, a filler, a catalyst; and curing the patterned silicone composition.

The coated patterned substrates of the invention consist of hydrophobic boundary regions and hydrophilic well regions (FIG. 1, Top View). The hydrophobic boundary regions provide a barrier between the adjacent hydrophilic wells where assaying reactions can be conducted. The patterned substrates of the present invention exhibit lower fluorescence, improved chemical durability to cleaning/coating/assaying processes, and a higher degree of pattern uniformity than PTFE based formulations. In certain embodiments the application of a surface-roughening agent after patterning (FIG. 1, Side View) is utilized to create pattern ultra-hydrophobicity (i.e., water contact angles form 140° up to 180°).

Novel, low fluorescent, chemically durable patterned architectures for application onto substrates have been achieved through the use of crosslinked multicomponent silicone-based formulations. The patterning material is preferably deposited by screen-printing onto a glass substrate to provide distinct boundary and well regions of different free surface energies. The use of low cost screen-printing methods with the formulations of this invention provides uniformly thick, customizable patterns for multiplexed microarraying applications. After application of the pattern, the silicone surface can be roughened if necessary before or after curing to boost the hydrophobicity of the patterned surface from about 100-120 to greater than 140 degrees to achieve ultra-hydrophobicity. The resulting patterned architecture is (ultra)-hydrophobic, chemically durable in detergent, acidic, and basic solutions that are typically used for glass cleaning, and has a low self-fluorescence when scanned under the excitation and emission conditions commonly used during a microarray experiment. The patterning architecture is also chemically durable to chemicals commonly used in biological experiments. The patterned substrates are useful for separating distinct biologically relevant target solutions during biomolecule, cell, and tissue assaying experiments.

When used for assaying, the patterned substrate is first cleaned and then coated with a chemically functional compound suitable for the direct or indirect attachment and/or immobilization of biologically relevant probes. Probes are then deposited into the discrete coated wells on the patterned substrates to form (multiple) arrays. The arrays can then be used to investigate multiple biologically relevant targets simultaneously, whereby the hydrophobic pattern provides a chemically durable, hydrophobic barrier to inter-well cross contamination. After the assay is completed, the arrays can be scanned using a commercially available scanner, with the hydrophobic pattern exhibiting exceptionally low fluorescence in the 400-800 nm range that is preferably <5×, more preferably <3-4×, and most preferably <1-2× that of the substrate. The pattern design itself is flexible, being limited only to the human imagination and the limitations of graphics programs used to make symmetrical or unsymmetrical geometric patterns (repeating or non-repeating over the substrate surface) that include ovals, squares, rectangles, stars, etc. that can be adapted to the experimental arraying/assaying design as needed. The wells may or may not be interconnected to provide a means for interaction between two or more wells on a substrate. Preferably text, symbols, designs, chamfers (FIG. 2) may be designed into the pattern to aid in registration, sample tracking, etc. More preferably edge marking (i.e., marking the edge(s) of the substrate) with the patterning material may also be used (FIG. 1, Side View).

The present invention relates generally to patterned substrates, particularly substrates which are suitable for the attachment of biologically relevant probes such as carbohydrates, nucleic acids, oligonucleotides, proteins and peptides, as well as cells and tissues. The invention also relates to hydrophobic patterned, low self-fluorescent substrates for attaching biomolecules and a method of making them. The patterned material will not interfere with assay analysis because the patterning composition is manufactured so to have very low self-fluorescence in the spectral regions typically used for microarraying applications. Further, the patterning compositions are chemically and physically durable and will not be deleteriously affected by typical chemical/physical processes utilized for clean ing/coating/assaying processes.

The present invention also relates to a method of preparing coated patterned substrates suitable for the attachment of biomolecules. Preferably, the low self-fluorescent, crosslinkable silicone patterning composition is screen-printed onto the substrate. After the patterning composition cures the substrate is further coated with a chemically functional compound to which other chemical moieties (e.g., biological probes, biomolecules, or fragments thereof) can be immobilized (i.e., chemically bound). Although a variety of substrates are contemplated, as long as compatible with the end use such as a bioassay, a preferred substrate is a low self-fluorescent glass, more preferably with a metal, metal oxide, non-metallic oxide, or dielectric coating as a first layer on a low self-fluorescent glass. The chemically functional compound to which probes can be attached is preferably a functionalized alkoxysilane, chlorosilane, hydrogel, or alkanethiol. If the substrate is gold coated, the preferred functional compound is a functionalized alkanethiol. Suitable probes which can be attached to the patterned and functionally coated substrates of the invention include DNA, modified or unmodified nucleic acids, antibodies, antigens, proteins, oligonucleotides, carbohydrates, sugars, any organism component (e.g., tissues or cells), biomolecules, or fragments thereof.

A preferred use of the present invention is to covalently or non-covalently immobilize a controlled density of biomolecules, preferably nucleic acid molecules, and particularly nucleic acid oligomers, onto the patterned and coated substrate. A most preferred use of the present invention is to provide chemically and physically durable substrates having partitioned surfaces with wells where multiple assays can be carried out without appreciable interwell cross contamination (FIGS. 3A-3B). The present invention thus can provide sensors, biosurfaces, or biomaterials for a variety of biological, analytical, electrical, or optical uses. The coated substrates can also be used as “adhesive scaffolds” upon which cell and tissue engineering can be conducted.

Thus, in general, the patterned and coated substrates of the present invention can be used in processes for detecting and/or assaying biologically relevant probes and targets. When a patterned and coated substrate as described above is used, the detection or assay can be carried out using a labeled target, fluorescent, radioisotope, or otherwise, which detects the presence of the attached probe. A more complete appreciation of the invention will be readily obtained by reference to the accompanying drawings, wherein:

### BRIEF DESCRIPTIONS OF THE DRAWINGS

FIG. 1 is a pictorial representation of a glass substrate demonstrating the separation of hydrophilic well regions by the hydrophobic boundary regions (top view), the optional inclusion of a roughening agent (side view), and the optional inclusion of an edge marking (using the patterning material) for registration.

FIG. 2 depicts examples of some of the possible patterns that can be designed for screen-printing application to substrates for arraying applications.

FIG. 3A is a view of six arrays of oligonucleotides 60 bases long in individual wells on a coated patterned substrate.

FIG. 3B is a close-up view of the six arrays from FIG. 3A showing the hybridization of three unique probe/target compliments with well-to-well cross contamination occurring at <2% observed signal intensity.

FIG. 4A gives a brief overview of silicon, silane, and silicone terminology and possible functional groups for silanes and silicones.

FIG. 4B demonstrates the crosslinking reactions of a vinyl containing silicone.

FIG. 4C demonstrates the crosslinking reactions of various functionalized silicones.

FIG. 5A depicts a SEM surface image of a patterned surface made from a commercially available perfluorinated ink that has particles dispersed in the ink (particles of a composition very similar to Zonyl®).

FIG. 5B is an SEM surface image of a silicone formulation that has Tullanox® 500 particles.

FIG. 6A is a 16-well hydrophobic pattern on borosilicate glass with a black colorant.

FIG. 6B is a 16-well hydrophobic pattern on borosilicate glass with no colorant added to the formulation.

FIG. 7 is a simplified representation of a multiplexed interaction experiment on a coated patterned glass substrate.

FIG. 8A depicts an 118° contact angle of water on a Silicone 110 pattern.

FIG. 8B depicts a 140° contact angle of water on a Silicone 140 pattern.

FIG. 9A shows an SEM image of a circular well. This image demonstrates the circularity of the wells and the uniform smoothness of the Silicone 110 coating.

FIG. 9B shows an SEM image of the pattern-to-well transition area (20 mm transition thickness) for a Silicone 110 coating.

FIG. 9C shows an SEM image of the pattern thickness uniformity (18±1 μm) for a Silicone 110 coating.

FIG. 10A is a LM image of the pattern-to-well transition area after curing for Silicone 130.

FIG. 10B is a LM image of the pattern-to-well transition area after cleaning for Silicone 130.

FIG. 10C is a WLI image of the pattern-to-well transition area after curing for Silicone 130.

FIG. 10D is a WLI image of the pattern-to-well transition area after cleaning for Silicone 130.

FIG. 10E is a WLI image of the pattern after curing for Silicone 130.

FIG. 10F is a WLI image of the pattern after cleaning for Silicone 130.

FIG. 10G is an SEM image of the pattern-to-well area after curing showing well contamination for Silicone 130.

FIG. 10H is an SEM image of the pattern-to-well area after cleaning showing cleaning effectiveness for Silicone 130.

FIG. 10I is an SEM image of a particle in the well after cleaning for Silicone 130.

FIG. 10J is an XPS spectra of the well particle in FIG. 10I, identified as Tullanox™.

FIG. 10K is an SEM image of the pattern after curing showing pattern surface morphology for Silicone 130.

FIG. 10L is an SEM image of the pattern after cleaning showing pattern surface morphology for Silicone 130.

FIG. 11A shows the fluorescent comparison between the patterning material of various commercial slides and silicone (110 and 140) based formulations.

FIG. 11B shows the fluorescent comparison of the wells between various commercial patterned substrates and silicone based formulations.

FIG. 11C visually shows the fluorescent images of (left-to-right) Tekdon, Erie, Silicone 110, Silicone 140, Cytonix, and unpatterned Schott borosilicate glass 3 under the identical scanning conditions.

FIG. 12A depicts a LM image of an Erie Scientific 96 well patterned slide before cleaning.

FIG. 12B depicts a LM image of an Erie. Scientific 96 well patterned slide after cleaning.

FIG. 12C depicts a LM image of a 96 well Cytonix perfluorinated ink patterned slide before cleaning.

FIG. 12D depicts a LM image of a 96 well Cytonix perfluorinated ink patterned slide after cleaning.

FIG. 12E depicts a LM image of a Silicone 110 16-well patterned substrate before cleaning.

FIG. 12F depicts a LM image of a Silicone 110 16-well patterned substrate after cleaning.

FIG. 12G depicts a LM image of a Silicone 140 16-well patterned substrate before cleaning.

FIG. 12H depicts a LM image of a Silicone 140 16-well patterned substrate after cleaning.

FIG. 13A depicts an SEM image of the thickness uniformity on the Silicone 110 formulation on a glass substrate.

FIG. 13B depicts an SEM image of an Erie Scientific patterned substrate showing thickness deviation.

FIG. 13C depicts an SEM image of the thickness variation in the Cytonix ink formulation on a Schott borosilicate glass 3 substrate.

Biologically relevant probes (biomolecules or fragments thereof, natural or synthetic, modified or unmodified) can be immobilized on a variety of solid surfaces, for a number of known applications, including: the creation of combinatorial complex carbohydrate arrays; DNA and RNA oligomer synthesis; separation of desired target nucleic acids from mixtures of nucleic acids including RNA; conducting sequence-specific hybridizations to detect desired genetic targets (DNA or RNA); creating affinity columns for mRNA isolation; quantification and purification of PCR reactions; characterization of nucleic acids by AFM and STM; for sequence determination of unknown DNAs, such as the human genome, etc. A number of methods have been employed to attach biomolecules to substrates. There are numerous patents and patent applications, which describe arrays of oligonucleotides and methods for their fabrication, and a variety of substrates for DNA immobilization, including polymeric membranes (nylon, nitrocellulose), magnetic particles, mica, glass or silica, gold, cellulose, and polystyrene, etc. They include: U.S. Pat. Nos. 5,077,210; 5,242,974; 5,384,261; 5,405,783; 5,412,087; 5,424,186; 5,429,807; 5,436,327; 5,445,934; 5,472,672; 5,527,681; 5,529,756; 5,545,531; 5,554,501; 5,556,752; 5,561,071; 5,599,895; 5,624,711; 5,639,603; 5,658,734; 5,677,126; 5,688,642; 5,700,637; 5,744,305; 5,760,130; 5,837,832; 5,843,655; 5,861,242; 5,874,974; 5,885,837; 5,919,626; PCT/US98/26245; WO 93/17126; WO 95/11995; WO 95/35505; EP 742 287; and EP 799 897. There are numerous patents and patent applications describing methods of using arrays in various applications, they include: U.S. Pat. Nos. 5,143,854; 5,288,644; 5,324,633; 5,432,049; 5,470,710; 5,492,806; 5,510,270; 5,525,464; 5,547,839; 5,580,732; 5,661,028; 5,848,659; 5,874,219; WO 95/21265; WO 96/31622; WO 97/10365; WO 97/27317; EP 373203; and EP 785 280. The techniques and uses in these documents are all applicable herein.

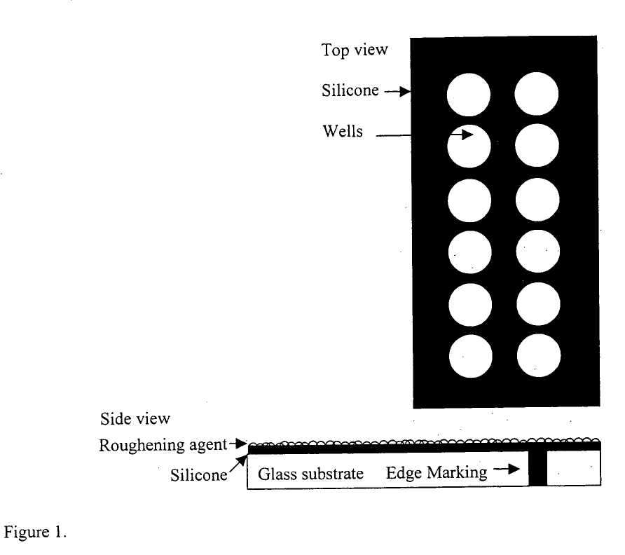

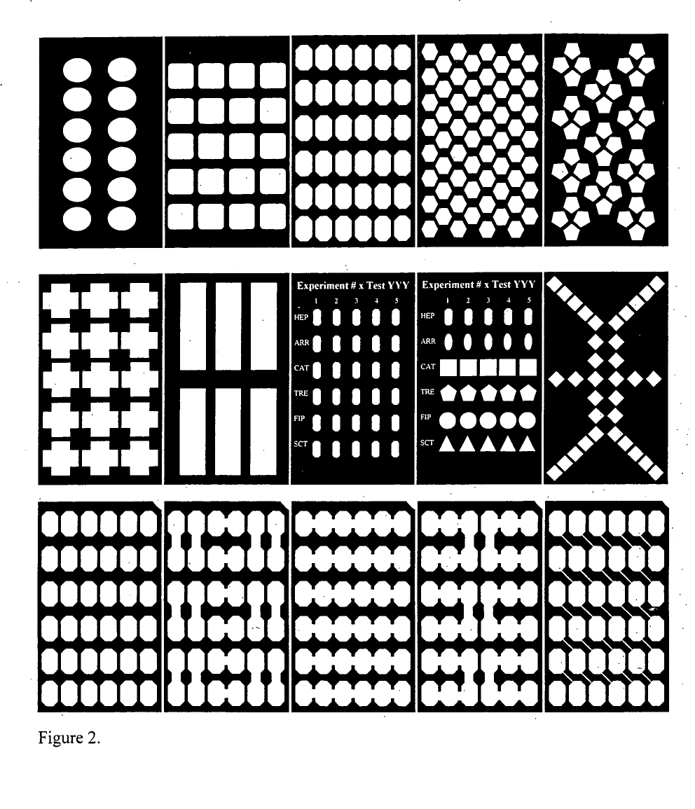

The substrates to be modified for use in the methods and products of the present invention include materials, which have or can be modified to have hydrophobic “boundary” regions and hydrophilic “well” regions (FIG. 1, Top View), typically having a surface free energy difference of about >10 dynes/cm between the boundary and well regions. The well regions have surface reactive groups or can be modified to have surface reactive groups, which can react with a chemically functional compound to which other chemical moieties can be bound. Suitable substrates are preferably inorganic materials, including but not limited to: silicon, glass, silica, diamond, quartz, alumina, silicon nitride, platinum, gold, aluminum, tungsten, titanium, and various other metals and ceramics. Alternatively, polymeric materials such as polyesters, polyamides, polyimides, acrylics, polyethers, polysulfones, fluoropolymers, etc. may be used as suitable organic substrates. The substrate used may be provided in any suitable form, such as slides, wafers, fibers, beads, particles, strands, precipitates, gels, sheets, tubing, spheres, containers, capillaries, pads, slices, films, plates, etc. The substrate may have any convenient shape, such as that of a disc, square, sphere, circle, etc. The support can further be fashioned as a bead, dipstick, test tube, pin, membrane, channel, capillary tube, column, or as an array of pins or glass fibers.

Although the substrate may be made of a variety of either flexible (plastic) or rigid (glass or plastic) solid supports, glass is the preferred solid substrate, preferably in the form of a microscope slide, more preferably in the form of a microtiter plate (MTP). Additionally, the substrate may also be a coverslip, capillary tube, glass bead, channel, glass plate, quartz wafer, a nylon or nitrocellulose membrane, or a silicon wafer. The solid support can also be plastic, preferably in the form of a microscope slide, more preferably in the form of a microtiter plate. Preferably, the plastic support is a form of polystyrene.

As mentioned above, an array can be present on either a flexible or rigid substrate. A flexible substrate is capable of being bent, folded, or similarly manipulated without breakage. Examples of solid materials which are flexible solid supports with respect to the present invention include membranes, e.g., nylon, flexible plastic films, and the like. By “rigid” it is meant that the support is solid and does not readily bend, i.e., the support is not flexible. As such, the rigid substrates for use in bioarrays are sufficient to provide physical support and structure to the associated biomolecules such as oligonucleotides and/or polynucleotides present thereon under the assay conditions in which the array is employed, particularly under high throughput handling conditions.

The substrate and its surface are also chosen to provide appropriate optical characteristics. In one preferred embodiment, the substrate is a low self-fluorescent glass such as certain formulations of borosilicate, soda-lime silicate, or pure SiO₂ glass. With respect to the substrate, by “low fluorescence” herein is typically meant less than 70 relative self fluorescent units (emission quata) when all background readings are scanned at 100% laser power at constant sensitivity and normalized for substrate thickness (photomultiplier tube gain PMT=700 axon using a GenePix Pro 3 scanner and software package). In another preferred embodiment, the substrate is a gold-coated substrate, such as gold-coated ceramic, gold-coated glass-ceramic, or a gold coated polymeric substrate, most preferably a gold coated glass. In another preferred embodiment, the substrate has a dielectric layer coated on top of a low self-fluorescent glass, consisting of metal and/or non-metal oxide layers. Other suitable substrates include those disclosed in US 20020044893A1; U.S. Pat. No. 6,127,129; EP 858 616; and U.S. Pat. No. 6,146,767. In addition, the substrate may also be a SiO₂ coated substrate or polymer such as (poly tetrafluoroethylene, (poly)vinylidenedifluoride, polystyrene, polycarbonate, etc., or combinations thereof. If the chosen substrate is glass, it is often desirable to clean the glass substrate prior to patterning or coating. Suitable cleaning can be achieved according to conventional glass cleaning protocols (J. J. Cras et al. Biosensors & Bioelectronics 1999, 14, 683-688 and references therein).

The patterning composition is also chosen to provide appropriate optical characteristics. The patterning composition preferably does not fluoresce appreciably above the fluorescence of the substrate in the spectral region that is of general importance for the end application, or in any other way significantly affects the ultimate end use of the patterned substrate. For instance, fluorescent characterization is the method of choice for nucleic acid and protein microarraying, and the most common dyes used for nucleic acid and protein microarraying (i.e., Fluor X™, Cy3™, and Cy5™ chemical dyes) have absorption maxima at 494 nm, 550 nm and 649 nm, and fluorescent emission maxima at 520 nm, 570 nm, and 670 nm, respectively. Many other visible dyes may also be used (e.g., Texas Red, Bodipy, etc.), commercially available from companies like Molecular Probes and Amersham. Therefore, the low self-fluorescent patterning composition, most preferably having no more than 1-2× fluorescence of the substrate, is formulated to low self-fluorescent by removing components that fluoress greater than 1-2× that of the substrate in the 400-800 nm spectral range.

The patterning compositions of the present invention are silicone based formulations. In general, silicones are polymers of silicon and oxygen repeat units. The polymers can either be linear or branched. Silicones have chemical and physical durability and have a good range/ease/commercial availability of a large number of functionalized silicones. Along the backbone of the polymer units pendent functional groups can be attached, such as various alkyls, aromatics, halogenated groups, hydroxyl, etc. At the ends of the polymers there are also a wide range of functional groups available (e.g., hydroxyl, vinyl, alkyl, hydride, amine, epoxy, carbinol, methacrylate, acrylate, mercapto, acetoxy, etc). The range of chemical reactivity of the aforementioned silicone polymers is quite versatile and allows a suitable chemical system to be formulated for the desired application. Silicones can form strong covalent bonds with glass substrates through —SiOH condensation reactions to form stable −Si—O—Si-linkages. These formulations can be designed to have useful working times, typically greater then one hour. Thus, through appropriate component selection, one can achieve a wide range of boundary region hydrophobicities of about 110-160° (water), and, in tandem with suitable manufacturing processes such as screen-printing and curing (e.g., thermal, UV), produce clean, wettable wells (e.g., <20° water contact angles). The term “cure” as used herein in connection with a composition, e.g., “curing the patterned silicone composition”, shall mean that any crosslinkable components of the composition are at least partially crosslinked by exposure to thermal, UV, IR, or other energy sources. In certain embodiments of the present invention, the crosslink density of the crosslinkable components ranges from 5-100% of complete crosslinking. In other embodiments, the crosslink density ranges from 35-85% of full crosslinking. In other embodiments, the crosslink density ranges from 50-85% of full crosslinking. One skilled in the art will understand that the presence and degree of crosslinking can be determined by a variety of methods, such as dynamic mechanical thermal analysis (DMTA) using a TA Instruments DMA 2980 DMTA analyzer. These formulations exhibit excellent chemical durability, are stable to exposure of strong acids (e.g. hydrochloric, dilute hydrofluoric), strong bases (e.g. sodium hydroxide), and commonly used microarraying, assaying, and biomolecular processing solutions e.g., toluene, n-methylpyrilidone, succinic anhydride, dichloroethane, ethanolamine, phosphate buffer solution, TWEEN (polyoxyethylene containing surfactant), bovine serum albumin, etc. Additionally, they are resistant to degradation via ultrasonication. Furthermore, the silicone patterning formulations have the ability to form patterns of high uniform thickness and preferably their fluorescence adds less than 2× that of the glass substrates when the excitation and emission occur in the 400-800 nm range.

To achieve a patterning formulation that has high uniformity, low fluorescence, chemical durability, and is hydrophobic, one has to consider the properties of the individual components of the patterning formulation and the application methodology. These include consideration of the pattern strength, hardness, consistency, curing temperature/curing method, working time, ease of compounding, and application. A patterned substrate should have suitable resistance to physical abrasion, such that casual/ordinary contact with the pattern will not result in the removal/deactivation of the pattern properties.

The functionalized silicone or silicones chosen as the network former can be of varying molecular weights or of varying viscosities, providing chemical durability to the patterning composition. Typically the functionalized silicone is present in from about 15-85%, preferably from about 20-80%, and most preferably from about 30-65% by weight of the patterning composition. In a preferred embodiment one first starts with a base silicone polymer that has two terminal vinyl (CH₂═CH—) functional groups. The silicone polymer is selected to have a viscosity range between 1-100,000 centistokes (CS). Alternatively, one can also use identical silicone functionalized polymers with different viscosities and blend them together to the desired viscosity level. The vinyl functional groups are used to react with hydride functional silicones to form a crosslinked polymer system.

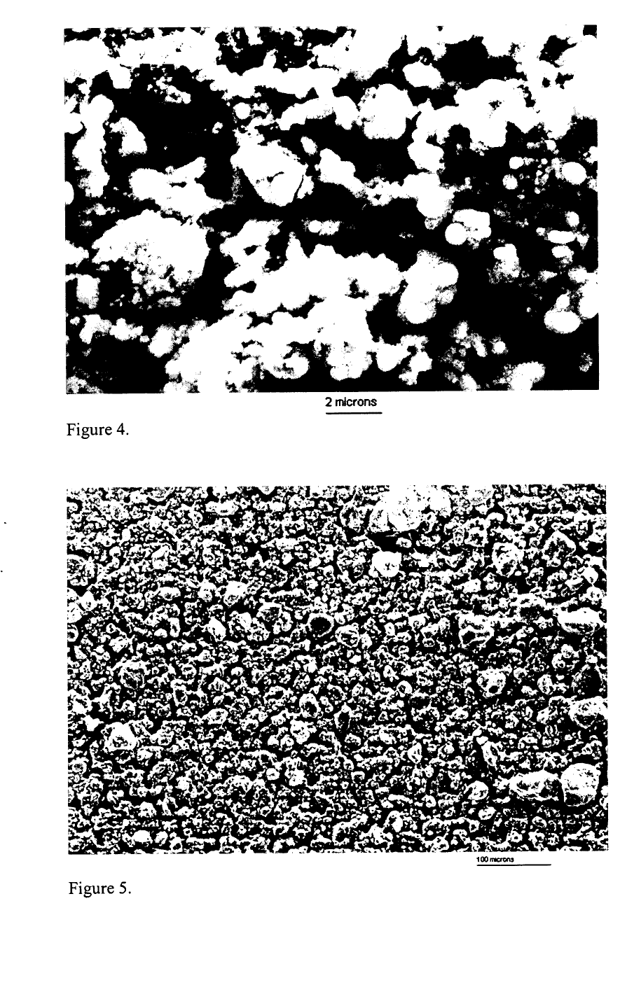

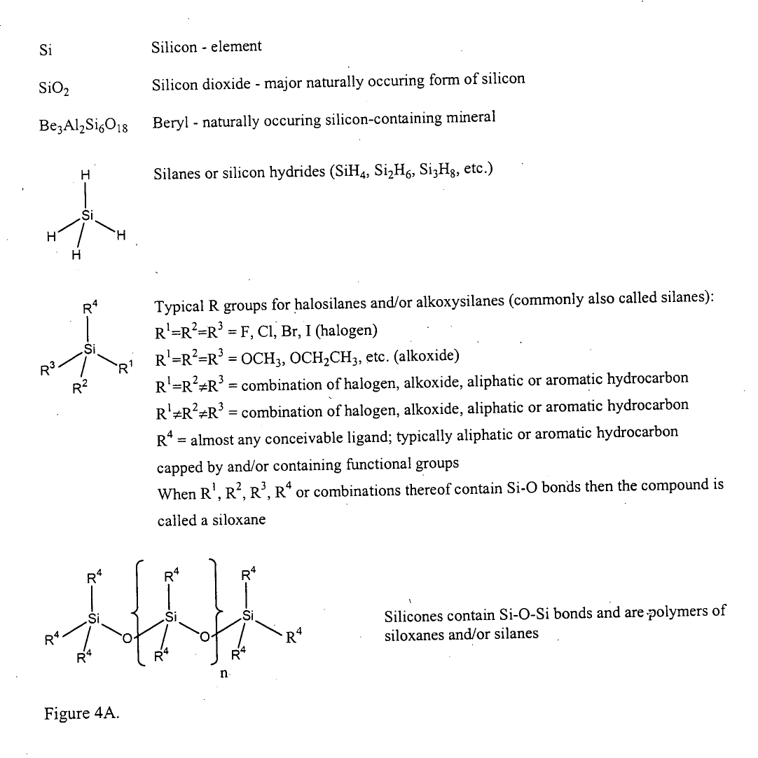

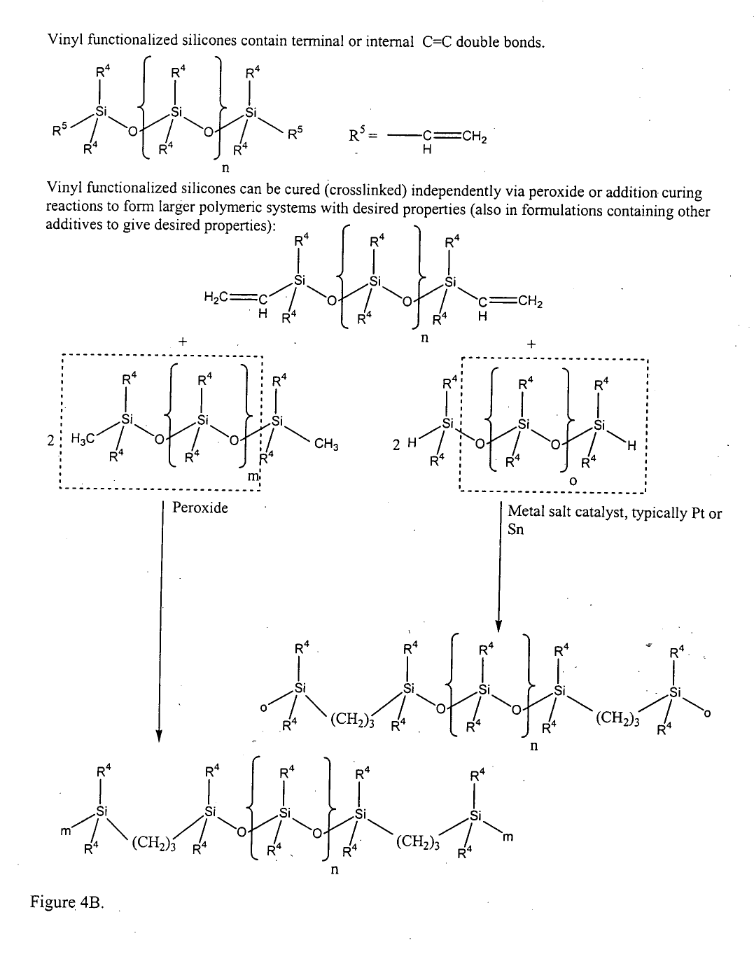

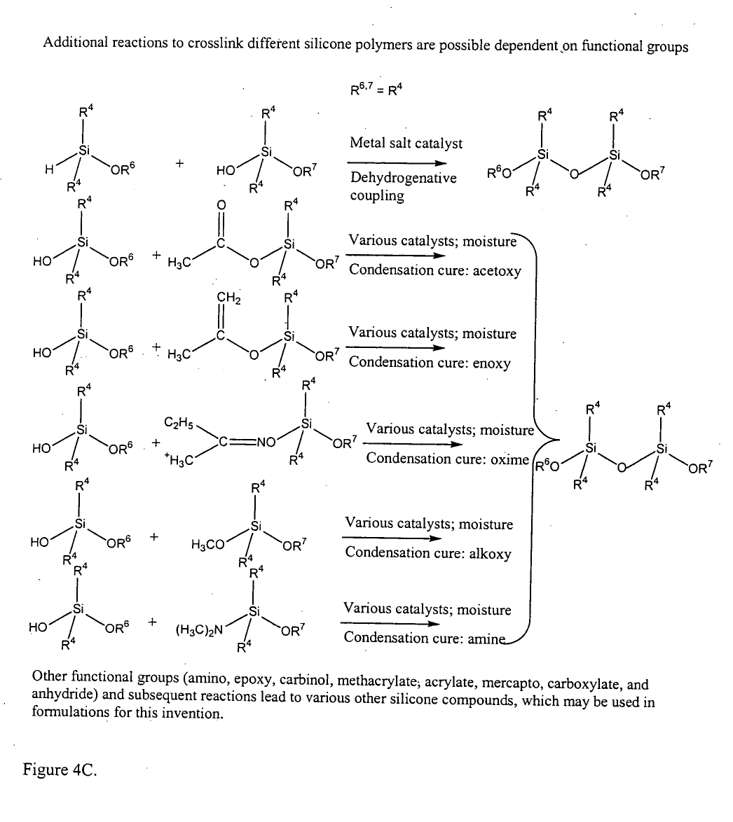

Although vinyl terminated silicones are most preferred, the crosslinkable silicone selected as the network former can be chosen from silicones having a variety of functional groups. The silicone network former should contain of at least one polysiloxane (silicone) comprising at least one reactive functional group (e.g., hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group such as an acrylate group or a methacrylate group, a maleimide group, a fumarate group, an onium salt group such as a sulfonium group, an ammonium group, an anhydride group, a hydroxy alkylamide group, an epoxy group). See FIGS. 4A-4C, for examples of silane/silicone terminology, vinyl containing silicone crosslinking reactions, and other functionalized silicone crosslinking reactions. Preferred base-polymer components of the present invention include vinyldimethylsiloxy-terminated polydimethylsiloxane, 1000-100000 centistokes viscosity, which are commercially available from Gelest and United Chemical Technologies.

The particle fillers used in the patterning compositions are selected to provide form and rigidity to the patterning composition. Without the addition of reinforcing fillers, silicone-patterning compositions tend to have very poor tensile and tear strength. The interaction between filler particles and the polysiloxane (silicone) matrix significantly increases the physical properties of silicones such as tear strength, tensile strength, and elongation before failure. Furthermore, the particle filler affects the consistency (flow-ability) of the formulation. The most commonly used fillers for silicones are fumed silica's with large surface area that have been surface treated to increase compatibility between the silicone polymer and the filler. Unlike organic polymers, silicone polymer by itself is relatively weak and produces tensile strengths of only 1.0 Mpa when crosslinked. To achieve useful engineering properties, it is often desirable to reinforce the silicone polymer by the addition of fine, high surface fillers which are compatible chemically with the silicone polymer. A common reinforcing filler used in silicone compositions is fumed silica, which is manufactured by burning silicon tetrachloride in the presence of hydrogen and oxygen. The silica particles produced are extremely fine and spherical in shape with surface areas as high as 325 m²/g but are amorphous, associating in string-like clusters that chemically interact with the Si—O polymer backbone yielding desirable reinforcement properties.

Precipitated silica's made through the acidification and precipitation of sodium silicate can also be used as reinforcing fillers in silicone compounds but often give weaker mechanical properties compared to fumed silica. These compounds are, however, very good in terms of low compression set and high resilience, and are more cost effective than their fumed silica counterparts. Other examples of suitable particle fillers which can be used in the invention include, but are not limited to, those available from GE Silicones, Waterford, N.Y., Dow Corning cured silicone elastomeric powders, Dow Corning Corporation, Midland, Mich., U.S. Pat. No. 5,188,899 to Matsumoto et al. and European Patent EP 822,232 (Toshiba Silicone Co., Ltd., Tokyo, Japan), U.S. Pat. No. 4,742,142 to Shimizu et al. (Toray Silicone Co., Ltd., Tokyo, Japan), and U.S. Pat. No. 4,962,165 to Bortnick et al. (Rohm. and Haas Co., Philadelphia, Pa.). Additionally, glass microbeads suitable for use as particle fillers in the invention are also commercially available from Flex-O-Lite Corporation, Fenton, Mo. and Nippon Electric Glass, Osaka, Japan. Furthermore, filler particles are commercially available under the brands of, for example, Monodisperse Polymer Particles MMP S2461 (R)-03 of Japan Synthetic Rubber Co., Ltd. and Acrylic Ultrafine Powder MP series of Soken Chemical Co., Ltd.

Silicone resin particles, which can be used as filler particles, include those containing molecular network structures of siloxane groups, such as siloxane-bonded alkyl groups, for example. One particular type of silicone resin particle which contains siloxane bonds and silicone groups bonded to methyl groups is those of the TOSPEARL™ series silicone particles (available from Toshiba Silicone Co., Ltd.), more specifically TOSPEARL™ 105 (silicone resin particles having a volume distributed median particle diameter of 0.5 μm), 120 (silicone resin particles having a volume distributed median particle diameter of 2.0 μm) and 130 (silicone resin particles having a volume distributed median particle diameter of 3.0 μm).

Particle filler shape is generally spheroid or ovoid, but variations in both size and shape will likely be present. For example, the silicone particles can be in the configuration of elongate fibers. Mixtures of varying geometrical particle configurations can be used as well. Particle surface morphology is generally smooth, although variations in surface morphology and structure are possible. For example, roughened or porous particle structures and mixtures can be used.

Particle filler size will vary according to the desired viscosity and micro-roughening effects. Additionally, the thickness of the coating layer and silicone polymer formulation used will affect the choice of particle filler size. Particle filler size can be generally described as fine particle size and can include particles having a diameter ranging from about 0.05 microns to about 25.0 microns, and typically from about 0.1 microns to about 12.0 microns. Preferably the particle size is <10 microns and most preferably would be from 0.2-3 microns. In the case of certain TOSPEARL™ particles such as TOSPEARL™ 105, for example, particle diameter range can vary from about 0.2 microns to about 0.8 microns.

It would be obvious to one skilled in the art that homogenous or, alternatively, heterogenous mixtures of different filler particles can be used in accordance with the invention provided they will not interfere with the desired low fluorescent optical properties or the desirable hydrophobic properties of the patterned architecture. Filler particles are preferably present in a % mass range of 1-70% of the patterning compositions, more preferably from 3-60%, and most preferably from 5-50%.

The addition of filler material into the patterning compositions also affects the viscosity of the patterning compositions. Viscosity is an important consideration when screen-printing silicone compositions. A preferred viscosity range would be from 100-200,000 centistokes, a more preferred range would be from 10,000-70,000 centistokes, and a most preferred range would be from 20,000-50,000 centistokes.

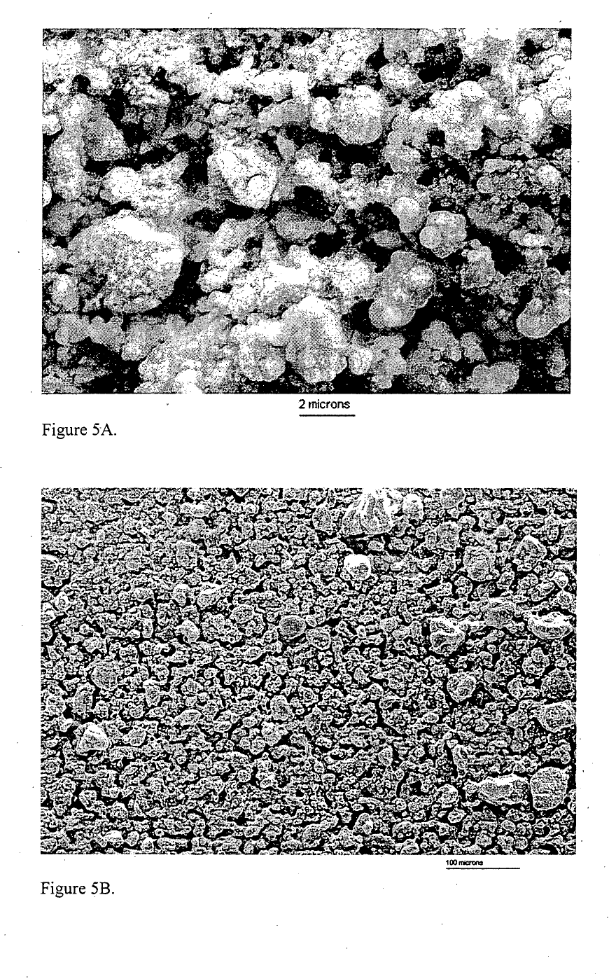

If desired, roughening agents (FIG. 1, Side View) may be added to the surface of the patterned substrates after screen-printing. Roughening agents act to increase the hydrophobicity of the resulting pattern. The roughening agent or a solution containing such agent may be applied topically by dipping, spraying, brushing, or stamping. A preferred method of application is by brushing. A more preferred method of application is by spraying, and a most preferred method of application is by dipping. These roughening agents are typically alkyl or fluoroalkyl coated particles with diameters in the micron and sub-micron range (<10 μm) that work by increasing the surface area of the deposited formulation. The particle filler materials used in the patterning compositions may also be used as roughening agents. Roughening agents may be added to the patterning compositions prior to printing to increase the pattern hydrophobicity; however they are preferably added after printing. The addition of roughening agents provides a greater hydrophobicity to aqueous liquids and thus a greater water repelling nature than a similar coating that does not contain roughening particles. Common examples of roughening agents are Zonyl® (FIG. 5A), Tospearl®, and Tullanox® (FIG. 5B). A hydrophobic fumed silica made by Tulco Inc., and sold under the name Tullanox™ has been found to provide excellent hydrophobic properties when applied to the patterning compositions used in the present invention. Tullanox™ is derived from fumed silica (99.8% SiO₂), the individual particles of which have chemically bonded to their surfaces hydrophobic trimethylsiloxyl groups. Tullanox™ (generally having particle diameters of 0.5 microns or less) has an extremely large surface area, enabling it to impart superior water-repellency when topically applied in relatively low concentrations to the printed patterning composition. The Tospearl® 120A, 130A, 145A (commercially available from GE Silicones) also provide excellent roughening properties. If roughening agents are desired they are typically applied to the printed pattern in amounts of from 0.0001-5% by weight of the patterning composition. Preferably, they are applied in amounts from 0.01-4% by weight, most preferably from 0.1-3% by weight.

The crosslinking density affects the hardness of the pattern. Thus, if one desires a harder pattern (i.e., more rigid and less gel like) one can increase the amount of crosslinker in the patterning formulation. The crosslinker acts to bond together the network former components and may aid in bonding to the substrate surface. Typically, the crosslinker is present in from 0.01-15% by weight of the composition. Preferably the crosslinker is present in from 0.1-10% by weight of the patterning composition. Most preferably the crosslinker is present in from 1.0 to 6 % by weight of the patterning composition. The choice of crosslinker for the present invention is dependent on the functionalized silicone, base polymer, and catalyst systems used. A non-exclusive list of suitable crosslinkers can be obtained from Gelest (Gelest 2000 catalog, pg 433-544) and is included herein by reference. For one preferred embodiment, crosslinking components of the present invention for vinyl-terminated silicones include methylhydrodimethyl-siloxane copolymers, polymethyl- and polyethyl-hydrosiloxanes, polyphenyl-(dimethylhydroxy)siloxane hydride terminated, polydimethylsiloxane hydride terminated, methyl hydrosiloxane-phenylmethylsiloxane copolymer hydride terminated, and methyl hydrosiloxane octylmethylsiloxane copolymer.

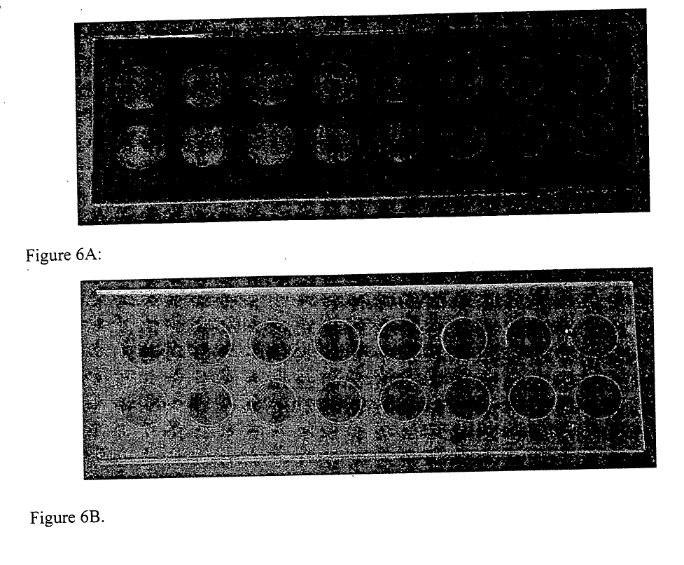

In certain applications it is often desirable for the pattern to have some colorant added to the formulation to aid in the contrast between the patterned boundary and the unpatterned well regions of the substrate (FIGS. 6A-6B). The colorant should not add appreciably to the self-fluorescence of the patterning material. If desired, colorants are typically present in the patterning formulations in from about 0-7%, preferably about 0.5-6%, and more preferably from about 1-5% by weight. Preferred colorant components of the present invention include carbon lampblack and cupric oxide (commercially available from Fisher) and pigment in silicone oil (commercially available from Gelest).

The curing and crosslinking reaction is generally carried out with the aid of a polymerization catalyst, such as, for example, zinc octoate, dibutyltin diacetate, ferric chloride, lead dioxide, tin octoate, dibutyltin dichloride, dibutyltin dibutoxide, ferric chloride, or mixtures of catalysts such as CAT50® (sold by Grace Specialty Polymers, Massachusetts). For one preferred embodiment, a most preferred catalyst family of the present invention for vinyl-terminated silicones are platinum containing complexes, two examples of which are platinum divinyltetramethyldi-siloxane complex in vinyl silicone and platinum octanoaldehyde octanol complex (commercially available from Gelest). Careful consideration is given to the appropriate catalyst as it affects the curing temperature. For example platinum in vinyidisiloxanes allow for room temperature curing while platinum in cyclic vinyldisiloxanes require a higher temperature cure. Metal salt catalysts (e.g., Pt or Sn) allow for dehydrogenative coupling. Alternatively, vinyl functional groups can also be reacted with methyl functional silicones to form a crosslinked polymer system, initated using peroxide. Depending on the particular silicone network former chosen, the selected catalyst is present in amounts of from 0.00001-4%, preferably from about 0.0001-2%, and most preferably from about 0.01-1% by weight of the patterning composition. A non-exhaustive list of suitable catalysts for compositions of the present invention can be obtained from Gelest (Gelest catalog 2000, pg 433-544).

Inhibitors (also commonly called moderators) act to increase the working time for the deposition of the patterning formulations by slowing down or retarding the reactivity of catalysts. If desired, they are typically used in from about 0-3%, preferably from about 0.0001-2.5%, and most preferably from about 0.001-2% by weight of the patterning composition. A preferred inhibitor component of the present invention includes 1,3,5,7-tetravinyl-1, 3,5,7-tetramethylcyclotetrasiloxane. A non-exhaustive list of suitable inhibitors for compositions of the present invention can be obtained from Gelest (Gelest catalog 2000, pg 433-544).

The process or methodology of producing an image on a substrate through use of a liquid formulation can be divided into three main generic categories. These categories are classified based on the properties of the substrate and/or image transfer device, and historically are known as intaglio, planographic, and relief printing. Intaglio printing (gravure) is defined as an image produced below or beneath the ink-containing surface. Planographic printing (lithography) is defined as an image produced at the same plane as the ink-containing surface. Relief printing (letterpress, flexography) is defined as an image produced above the ink-containing surface. Recent advances in the printing industry have led to the development of several processes not neatly classified by the historical categorization of printing. Examples of these processes are ink transfer through a surface, non-impact, digital device, and combinations thereof (compound). Ink transfer through a surface (e.g., screen-printing or stencil duplicating) is a process where the medium is porous to the formulation, the formulation being mechanically forced through the medium. Non-impact processes (ink-jet printing) provide the ink to the substrate by projection onto the substrates surface, with no physical contact of the medium and substrate. Digital device printing (xerography) is based on the method of photocopying, the transfer of an image to a substrate using a computerized image. Offset printing is a printing process where ink from a printing plate is transferred to the substrate indirectly via a cylinder. Tampon printing is a printing process where ink from an etched metallic plate is transferred onto a flexible pad (tampon) that is used to pattern the substrate of interest. Stamping is a printing process where the ink is applied to a flexible or rigid pattern that is then pressed onto the substrate. As with any printing process, there are advantages and disadvantages to each method and the method selected will be dependent on many factors.

The preferred method of applying the patterning formulation of the present invention is screen-printing based on a combination of factors such as method flexibility, cost-effective equipment requirements, desired range of resolution, and simplicity of method. While other patterning methods are available, the preferred method, which meets the desired requirements as a patterning method for this invention, is screen-printing. One of the main alternative patterning methods is photolithography, widely used in the semiconductor industry. However, in most cases, photolithography is not as preferred as screen-printing for patterning due to its higher cost, longer and more involved (equipment, time, money) methodology, and excess resolution (photolithography good for 1 micron resolution; 10-100 micron resolution for most microarraying applications is adequate). In a preferred embodiment screen-printing is used to apply the patterning composition to the substrate. Equipment such as the SA-12, available from Systematic Automation Inc. provides reliable screen-printing. Polyester fiber screens of various mesh sizes are commercially available from EM Screens.

A preferred method of curing is through the use of thermal energy. Thermal curing can be done in a convection oven, vacuum oven, by infrared exposure, over a hotplate, or any other conventional means for producing even heat to a substrate. A preferred method of thermal curing uses a vacuum oven. A most preferred method of thermal curing uses a convection oven. A temperature range of about 20-250° C. with times of about 1-48 hours is useful. A curing temperature range of about 100-250° C. with times of about 4-24 hours is preferred. A curing temperature range of about 180-250° C. with times of about 6-18 hours is most preferred. Alternatively, there are numerous methods of curing that would be suitable and that are known to one skilled in the art. Namely, UV-curing or use of formulations that have quick set-up times and thus need either reduced thermal curing time or cure at ambient temperatures.

After curing has taken place it is often desirable to clean the patterned substrates of the present invention. One skilled in the art can choose from the myriad of possibilities for glass cleaning protocols. These include the use of acids, bases, and detergents, with varying times/temperatures, with varying rinse steps in-between. A preferred cleaning method is sequential exposure of the cured and patterned substrate to detergent, water, base, water, acid, water, and then drying. A more preferred cleaning method is sequential exposure to detergent/base, water, detergent/acid, water, and then drying. A most preferred cleaning method is sequential exposure to elevated temperature solutions of detergent/base, water, detergent/acid, water, and then drying.

The chemically functional compound to which other chemical moieties can be bound is also selected to avoid adding significant fluorescence during a microarraying experiment. The functional compound can bind to the hydrophilic well regions of the patterned substrate (for example, by condensation reactions in the case of glass/silane interaction, or elimination reactions in the case of glass/gold/thiol reactions). The chemically functionalized compound is selected to impart functionality to the glass surface (e.g., primary, secondary or tertiary amines, aldehyde, carboxylate, cyanate, epoxide, ester, ether, chloro, bromo iodo, ketone, vinyl, acrylate, ethylene glycol, fluoro, hydroxy, isocyanate, isothiocyanate, NHS ester, thiol, mercaptan, sulfhydryl, etc.) for the direct or indirect immobilization of biologically relevant probes through one or more intermediate functionalized compounds bonded to the first chemically functional compound. Such compounds are well known and their functionality is useful for many biological and industrial applications. In particular, amino and epoxy silane coated substrates are commonly used for preparing DNA and protein microarrays. Preferred chemically functional compounds include alkanethiols and a wide variety of silanes, preferably epoxysilanes such as epoxycyclohexyl ethyltrimethoxysilane or glycidoxyproply trimethoxysilane, and most preferably aminosilanes such as aminopropyltrimethoxysilane (APS), aminopropyl-trialkoxysilane, aminobutyldimethylmethoxy-silane, and multiaminosilanes having more than one amine group. Suitable chemically functional compounds may be, for example, mono- or multi-aminoalkyl monoalkoxysilane, mono- or multi-amino-alkyl dialkoxy silane, and/or a mono- or multi-aminoalkyl trialkoxysilane. Also suitable are multiaminoorganosilanes such as trimethoxysilylpropyl-diethylenetriamine (DETA), N-(2-aminoethyl)-3-aminopropyltrimethoxysilane (EDA), and/or (aminoethyl aminomethyl)phenethyltrimethoxysilane (PEDA). Also suitable are hydrogels, which are polymer networks capable of swelling in water. Typical hydrogels are derived from carbohydrates (chitosan, alginates, hyaluronic acid, etc.), proteins (e.g., collagen), and synthetic polymers, the most predominant ones being polyethylene glycols, nitrocellulose, polyurethane, etc. There are numerous methods of producing hydrogels, which would be suitable for use as the chemically functional compound of the present invention. See for example Hennink WE Adv. Drug Deliv. Rev. 54:13-36 (2000) and Gehrke SF NY Acad. Sci. 831:179-207 (1997).

The coating of the chemically functional compound can be performed directly onto the substrate surface either before the patterning composition is applied or after. However, coating of the chemically functional compound subsequent to patterning is preferred. Coating of the chemically functional compound can be performed directly onto a patterned or un-patterned substrate surface containing optional modification layers, such as metallic or non-metallic oxide layer(s), or metal(s). Such chemically functional modification layers used for modification of optical properties, when present, will generally range in thickness from a monomolecular thickness (typically <5 nm) to about several hundred microns.

The chemically functional coatings of this invention can be continuous or discontinuous coatings. Often the chemically functional coating layer will be a monolayer. A monolayer coating is defined herein as an organic, inorganic or organometallic film that is formed on a substrate surface, whereby the film thickness is similar to the molecular size of the coating precursor. For example, a monolayer silane coating on glass typically has a thickness of <5 nm, because a uniform film of a silane molecules in formed on the glass surface, and most functionalized silane molecules have a length of <5 nm. The use of self-assembled monolayers (SAMs) on surfaces for binding and detection of biological molecules has recently been explored. See for example WO 98/20162; PCT US98/12430; PCT US98/12082; PCT US99/01705; PCT/US99/21683; PCT/US99/10104; PCT/US99/01703; PCT/US00/31233; U.S. Pat. Nos. 5,620,850; 6,197,515; 6,013,459; 6,013,170; 6,065,573; and references cited therein. Multilayer coatings are also contemplated. A multilayer coating is defined herein as an organic, inorganic or organometallic film that is formed on a substrate surface, whereby the film thickness is some integer multiple of the molecular size of the starting precursor.

A typical protocol for subsequent coating of a patterned substrate using a chemically functional compound can be accomplished by dip-coating a clean patterned substrate in the coating composition 0.01-100 wt % chemically functional molecules and residual solvents solution for 5-30 min. Preferably the chemically functional molecules comprises from 1-10%, more preferably 2-8%, and most preferably 4-6 wt % of the coating composition. The coating composition can contain 0-20 wt % of H₂O and 5-99.9 wt % of an organic solvent such as acetone, toluene, isopropanol, methanol, ether, or ethanol. Acids or bases may be used to adjust pH in an aqueous containing solution, but the coating solution is generally maintained at a pH of 1-14, more preferably at a pH of 4-12 and most preferably at a pH of 9-11 for glass substrate coating applications. After dip coating, the substrates are then shaken in methanol, ethanol, and/or isopropanol again for about 0.1-24 hours and/or rinsed well with distilled or deionized H₂O for about 0.1-24 hours. After rinsing the substrates are spin dried for about 5 minutes at 1000 rpm and heat-treated at a temperature of 25-250° C. for 0.1-24 hours, preferably at a temperature of 100-140° C., and most preferably at a temperature of 110-130° C. Coatings can also be achieved through thermal chemical vapor deposition (T-CVD). During T-CVD the chemically functional coating composition is vaporized and brought into a chamber that contains clean substrates. The coating molecules adsorb onto the clean substrates and subsequently form covalent bonds through condensation and/or elimination reactions. This bonding can be accelerated through the use of heat. T-CVD can be conducted at 25-250° C., more preferably at 50-200° C., and most preferably at 100-190° C.

The chemically functional coating is preferably applied to the substrate by chemical vapor deposition, sputtering, dip coating, spin coating, ion beam deposition, flame hydrolysis deposition, laser pyrolysis deposition, liquid phase deposition in a reactor, electron beam deposition, plasma arc deposition or evaporation deposition, but other techniques can be used.

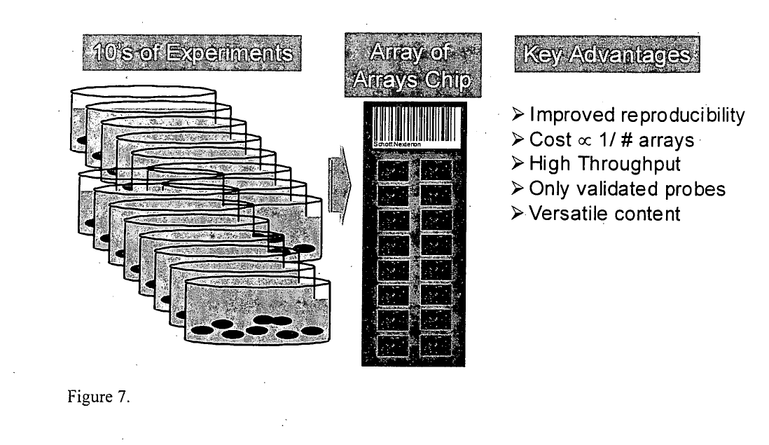

The patterned and functionally coated surfaces thus obtained are useful for attaching probes and detecting targets (see FIG. 7 for example; e.g., biologically relevant moieties such as cells, tissues, proteins, nucleic acids, lipids, sugars, carbohydrates, polysaccharides, RNA, DNA and derivatives thereof, as well as small molecules), e.g., by covalent, ionic, hydrogen bonding, hybridization, specificity interactions, etc. Typically, small molecules are of a nonpolymeric nature and include, but are not limited to, organic or inorganic compounds having a molecular weight less than about 10,000 grams per mole, preferably organic or inorganic compounds having a molecular weight less than about 5,000 grams per mole, and more preferably organic or inorganic compounds having a molecular weight less than about 1,000 grams per mole. A nucleic acid is a covalently linked sequence of nucleotides and includes “polynucleotides,” a nucleic acid containing a sequence that is greater than about 100 nucleotides in length; oligonucleotides, a short polynucleotide or a portion of a polynucleotide; and SNPs (single nucleotide polymorphisms) which are oligonucleotides or polynucleotides with a one base pair mismatch at a particular nucleic acid position. As used herein, the term “target nucleic acid” or “nucleic acid target” refers to a particular nucleic acid sequence of interest. Thus, the “target” can exist in the presence of other nucleic acid molecules or within a larger nucleic acid molecule. Among the proteins are included any polyaminoacid chain, peptides, protein fragments and different types of proteins (e.g., structural, membrane, enzymes, antigens, antibodies, ligands, receptors) produced naturally or recombinantly, as well as the derivatives of these compounds, etc.

All RNA and DNA are included, e.g., alpha-, beta-derivatives as well as aminothiol derivatives and mixed compounds such as PNAs. Mixed compounds such as glycoproteins, glycopeptides and lipopolysaccharides for example, or alternatively other elements such as viruses, cells, or chemical compounds such as biotin, can also be attached.

Thus, in general, the patterned and functionally coated substrates of the present invention can be used in processes for detecting and/or assaying probes and targets of biological relevance in a sample. If the detection reagent chosen is fluorescently labeled, the patterning composition and the functional coating are selected so as to have very low self-fluorescence. The activity of the probe may be maintained after immobilization to the surface. For example, immobilized DNA or RNA probes may retain their ability to hybridize to a complementary DNA or RNA molecule in a sequence-specific manner, or to function as primers for nucleic acid amplification techniques.

Pin spotting and ink jet printing are the most common techniques used to place small volumes (spots) of solution, which contain known probes, into the functionally coated hydrophilic wells of the patterned substrates. An ideal solid support for microarray applications would have zero self-fluorescence in the spectral region used for assaying, would be chemically and physically inert to chemical or physical processes used in assaying, would provide barriers to cross contamination between wells and would immobilize probes that are pin spotted or ink jet printed into the wells. After immobilization is achieved, the probe/coated patterned substrate interactions should be strong enough that they remain immobilized at their deposited location through washing and hybridization (probe/target interaction) processes.

With an automated delivery system, such as a Hamilton robot {e.g., Hamilton 2200 pipeting robot (Hamilton, Inc., Reno, Nev.)}, contact printer, or ink-jet printing method, it is possible to form a complex array of probes on a solid support, in particular onto patterned and functionally coated solid substrates. Such methods can deliver nano to pico-liter size droplets with sub-millimeter spacing. Because the aqueous droplets are well defined on coated surfaces, it is possible to create an array with a medium density of probes of ≦4000 probe droplets/cm². Such arrays can be assembled through the use of a robotic liquid dispenser (such as an ink-jet printing device controlled by a piezoelectric droplet generator). Methods and apparatus for dispensing small amount of fluids using such ink-jet printing techniques and piezoelectric ink-jet depositions have been previously described by Wallace et al. (U.S. Pat. No. 4,812,856), Hayes et al. (U.S. Pat. No. 5,053,100), both of which are herein incorporated by reference in their entirety. The array can also be created by means of a “gene pen”. A “gene pen” refers to a mechanical apparatus comprising a reservoir for a reagent solution connected to a printing tip. The printing tip further comprises a means for mechanically controlling the solution flow. A multiplicity of “gene pens” or printing tips may be tightly clustered together into an array, with each tip connected to a separate reagent reservoir or discrete “gene pens” may be contained in an indexing turntable and printed individually. Alternatively, the array can be created with a manual delivery system, such as a pipetman. Because these arrays are created with a manual delivery system, these arrays will generally not be as complex as those created with an automated delivery system. Arrays created with a manual delivery system will typically be spaced further apart. Preferably, arrays created with a manual delivery system will be created in a 96- or 384-well plate or larger.

Another preferred use of the patterned and functionally coated substrates of the present invention is for creating carbohydrate arrays, which can be exploited in a variety of ways, including, but not limited to, (i) identification of complex carbohydrate drugs; (ii) identification of complex carbohydrate associated receptors or proteins as potential new carbohydrate related targets for drug therapy; (iii) identification of biologically-active complex carbohydrates; (iv) identification of specific complex structural carbohydrate elements as potential new targets for drug therapy; (v) identification of the active sites of known complex carbohydrate structures; (vi) identification of new glycomarkers in complex carbohydrate structures; and (vii) detection of antibodies formed against a cancer-related glyco-epitope or other disease related glycoantigens.

Another preferred use of the patterned and functionally coated substrates of the present invention is for creating an array of DNA microarrays. Arrays are generally comprised of known, single-stranded nucleic acid fragments that are attached to a solid support in known locations. The DNA microarray is generally used as a tool for identifying the interaction of single-stranded cDNA fragments (targets) that exist in a buffered solution with probes. These targets are often formed during expression analysis or SNP detection experiments, and are tagged with a fluorescent dye for identification purposes.

Although fluorescence is a preferred labeling method for probe/target interaction, any detection method can be used. A label, tag, radioisotope, molecule, or any substance, which emits a detectable signal or is capable of generating such a signal (e.g., luminescence enzyme), or can be detected through analytical methods, or any of the variety of known signaling entities, is useful.

In a preferred embodiment, the analytical output is detected by fluorescent spectroscopic scanners (Axon, Tecan, Perkin Elmer, API), using fluorescent dyes that strongly fluoresce in the spectral regions where the substrate, the patterning composition, and the chemically functional coating fluorescence is minimal. Use of a wide variety of fluorescence detection methods is contemplated. For example, the fluor (fluorescent dye) can be coupled directly to the functional groups or backbone of the nucleotides of the probe (Ried, T. et al., Proc. Natl. Acad. Sci. (U.S.A.) 89:1388-1392 (1992), and U.S. Pat. Nos. 4,687,732; 4,711,955; 5,328,824; and 5,449,767, each herein incorporated by reference) or target. Alternatively, the fluor may be indirectly coupled to the nucleotide, as for example, by conjugating the fluor to a ligand capable of binding to a modified nucleotide residue.

The most common fluorescent dyes used for DNA microarray applications are Cy3™ and Cy5™. The Cy3™ absorption and emission windows are centered at 550 nm and 570 nm, respectively, while the Cy5™ absorption and emission windows are centered at 649 nm and 670 nm, respectively. Although Cy3™ and Cy5™ are the most common fluors for detecting assay activity, other fluors can be used such as 4′-6-diamidino 2-phenyl indole (DAPI), fluorescein (FITC), and the new generation cyanine dyes Cy3.5, Cy5.5 and Cy7. Of these, Cy3, Cy3.5, Cy5 and Cy7 are particularly preferred. The absorption and emission maxima for the respective fluors are: DAPI (absorption maximum: 350 nm; emission maximum: 456 nm), FITC (absorption maximum: 490 nm; emission maximum: 520 nm), Cy3 (absorption maximum: 550 nm; emission maximum: 570 nm), Cy3.5 (absorption maximum: 581 nm; emission maximum: 588 nm), Cy5 (absorption maximum: 649 nm; emission maximum: 670 nm), Cy7 (absorption maximum: 755 nm; emission maximum: 778 nm). Complete properties of selected fluorescent labeling reagents are provided by Waggoner, A. {Methods in Enzymology 246:362-373 (1995) herein incorporated by reference}. In light of the above, it is readily apparent that other fluorophores having adequate spectral resolution can alternatively be employed in accordance with the methods of the present invention.

The disclosures of U.S. Pat. Nos. 5,348,853; 5,119,801; 5,312,728; 5,962,233; 5,945,283; 5,876,930; 5,723,591; 5,691,146; and 5,866,336 disclosing fluorophore labeled oligonucleotides are incorporated herein by reference. Guidance for making fluorescent intensity measurements and for relating them to quantities of analytes is available in the literature relating to chemical and molecular analysis, e.g. Guilbault, editor, Practical Fluorescence, Second Edition (Marcel Dekker, New York, 1990); Pesce et al, editors, Fluorescence Spectroscopy (Marcel Dekker, New York, 1971); White et al, Fluorescence Analysis: A Practical Approach (Marcel Dekker, New York, 1970); and the like.

These specific examples are not intended to limit the scope of the invention described in this application. Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever. In the foregoing and in the following examples, all temperatures are set forth uncorrected in degrees Celsius; unless otherwise indicated, all parts and percentages are by weight; contact angles reported are for water; the # designation in the Silicone type indicates the approximate contact angle of the patterned surface.

### EXAMPLES

### Example I

### Comparison of Two Different Formulations of Low-Fluorescent, Chemically Durable Hydrophobic Silicone Patterning Compositions

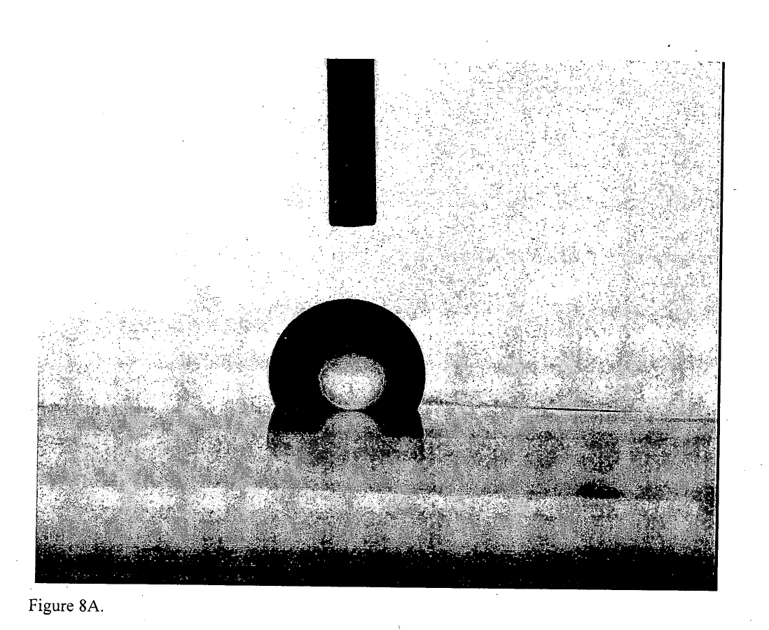

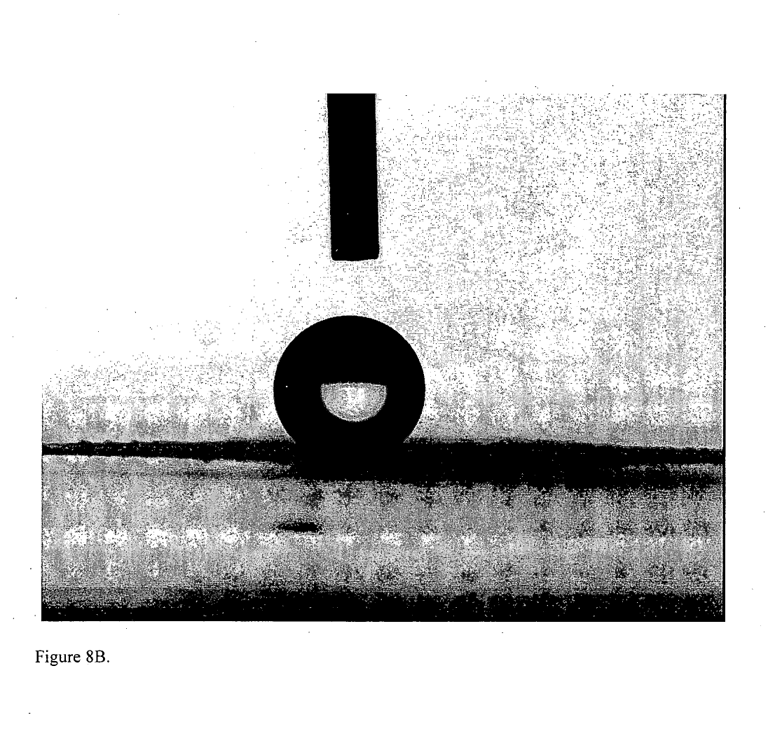

Table 1 summarizes the representative properties of two exemplary patterning compositions of the present invention, Silicone 110 and Silicone 140, with comparison to commercially available PTFE patterned substrates. Silicone 110, which does not having an added surface roughening agent, exhibits contact angles of about 110-120°, shown in FIG. 8A. Silicone 140, which has an added surface-roughening agent, exhibits contact angles of about 135-155°, shown in FIG. 8B. The optional addition of surface roughening agent(s) and the method of their application enables one to make a variety of hydrophobic patterns that have contact angles from about 110-155°.

TABLE 1
Representative data for hydrophobic silicone pattern on borosilicate
glass 3 with comparisons to commercially available patterned substrates that are
based on PTFE.

| | Silicone | Silicone | | | |
|---|---|---|---|---|---|
| Experiment | 110 | 140 | Tekdon | Erie | Cytonix Ink |
| Pattern contact angle | 110-120° | 135-155° | 150-160° | 150-160° | 145-165° |
| Pattern fluorescence Cy3¹ | 230 ± 30 | 690 ± 30 | 64600 ± 1250 | 13710 ± 870 | 14600 ± 2920 |
| Pattern fluorescence Cy5¹ | 36 ± 1 | 41 ± 1 | 2500 ± 350 | 210 ± 10 | 230 ± 40 |
| Pattern thickness | 18 ± 2 μm | 15 ± 2 μm | 14 ± 10 μm | 14 ± 7 μm | 16 ± 8 μm |
| Pattern-to-well transition | ≈20 μm | ≈20 μm | ≈100 μm | ≈30 μm | ≈50 μm |
| thickness | | | | | |
| Well contact angle² | <20° | <20° | ≈35° | ≈20° | <10° |
| Well fluorescence Cy3¹ | 180 ± 5 | 126 ± 3 | 4250 ± 1550 | 1030 ± 80 | 450 ± 50 |
| Well fluorescence Cy5¹ | 46 ± 1 | 43 ± 1 | 54 ± 1 | 71 ± 6 | 47 ± 2 |
| Well contaminants (1 = low; | 1 | 2 | 4 | 2 | 2 |
| 5 = high) | | | | | |
| Chemical durability: 1% | Pass | Pass | Pass | Pass | Pass |
| (v/v) HCl for 15 min at 20° C. | | | | | |
| Chemical durability: 1% | Pass | Pass | Not Tested | Not Tested | Fail |
| (v/v) AHF for 5 min at 20° C. | | | | | |
| Chemical durability: 10% | Pass | Pass | Fail | Not Tested | Fail |
| (w/v) NaOH for 5 min at | | | | | |
| 70° C. | | | | | |
| Chemical durability to | Pass | Pass | Not Tested | Not Tested | Pass |
| biological solutions³ | | | | | |

¹Pattern & well fluorescence measured under identical scanning conditions: Axon 4000B scanner, PMT 600 V, 100% laser power, 10 μm/pixel resolution, under Cy3 & Cy5 excitation & emission conditions (units are quanta). Average values are for interslide comparison, minimum 3 samples. Values quoted are for patterned microscope glass slides directly from the manufacturer (Erie, Tekdon) and after curing (Cytonix, Silicone 110, Silicone 140).
²For commercially available Erie and Tekdon the contact angles were measured for the slides as received with no additional cleaning (nitrogen dusting only to remove gross particulates).
³Biological solutions tested include 50 mM ethanolamine/50 mM borate (4 hours), phosphate buffer solution/0.5% tween (a detergent - 40 minutes), phosphate buffer solution/1% bovine serum albumin (1 hour), and 4-(2-hydroxyethyl)-1-piperazineethanesulfonic acid (HEPES; 4 hours).

PTFE based formulations exhibit significant fluorescence in the 400-800 nm range (common spectral range for fluorescence based detection), greater than 200 times that of commonly used soda-lime silicate and borosilicate glass substrates at 570 nm (Cy3 dye emission detection wavelength), and greater than 5 times that of the glass substrates used at 670 nm (Cy5 dye emission detection wavelength).

### Example II

### General Procedure for Preparation of Silicone 110, 130, and 140 Patterns on Glass Substrate

TABLE 2
General formulation scheme for silicone patterning.

| Formulation | | | |
|---|---|---|---|
| Component | Example Reagents | Weight % | Function |
| Network former¹ | Functionalized silicones of | 20-80% | Provides chemical durability |
| | varying molecular weight & | | |
| | viscosities | | |
| Filler | Tospearl ®; Fumed SiO₂; | 5-60% | Provides form and rigidity |
| | Functionalized SiO₂ (HMDS); | | |
| | Glass spheres; Flex-o-lite | | |
| | microspheres | | |
| Colorant | Carbon black; Metal oxides | 0.1-5% | Provides region contrast |
| | (e.g. CuO); Pigment | | |
| Crosslinker | Methylhydrosiloxane | 0.1-10% | Bonds together the network |
| | dimethylsiloxane co-polymer; | | former components |
| | Hydride containing silicones | | |
| Catalyst | Platinum-divinyltetramethyldisiloxane | 0.0001-2% | Induces crosslinking |
| | complex in xylene | | |
| Inhibitor | 1,3-Divinyltetramethyl | 0.0001-2% | Increases batch life |
| | disiloxane; 1,3,5,7-tetravinyl- | | |
| | 1,3,5,7-tetramethylcyclotetrasiloxane | | |
| Roughening | Tullanox ®; Tospearl ®; | 0.0001-5% | Added to achieve ultra- |
| Agent² | Functionalized SiO₂ | | hydrophobicity |

¹Network former can also be multicomponent mixture of functionalized PDMS (polydimethylsiloxane), functionalized silicones, or monomeric siloxanes.
²Roughening agent added to Silicone 130 & 140, not present in Silicone 110.

Using the general scheme of formulations as referenced in Table 2, the following process is followed for forming Silicone 110 & 140 patterned substrates.
1) The network former/base components are mixed together to the desired viscosity. Filler component, colorant, crosslinker, inhibitor, and catalyst are added sequentially.
2) The formulation is printed onto substrates via screen-printing. There are a myriad of variables optimized, including screen mesh size, emulsion thickness, emulsion exposure time, pattern image, registration of screen in unit, formulation viscosity, formulation workability time, formulation volume, and screen cleaning.
3) After screen-printing a roughening agent optionally is added to the formulation to increase the hydrophobicity of the pattern for Silcone 140. This is accomplished through the topical application of the roughening agent by the methods of dipping and/or spraying.
4) After the optional application of the roughening agent the formulation is allowed to harden through a thermal convection curing process at a temperature range of 180-250° C., for between 6-18 hours.
5) After curing, the substrates are cleaned to remove adventitious contamination (from curing step and/or atmosphere) from the well areas. Contamination is higher (as observed by contact angle measurements) for substrates undergoing high temperature thermal cures.

### Example III

### Silicone 110 Formulation

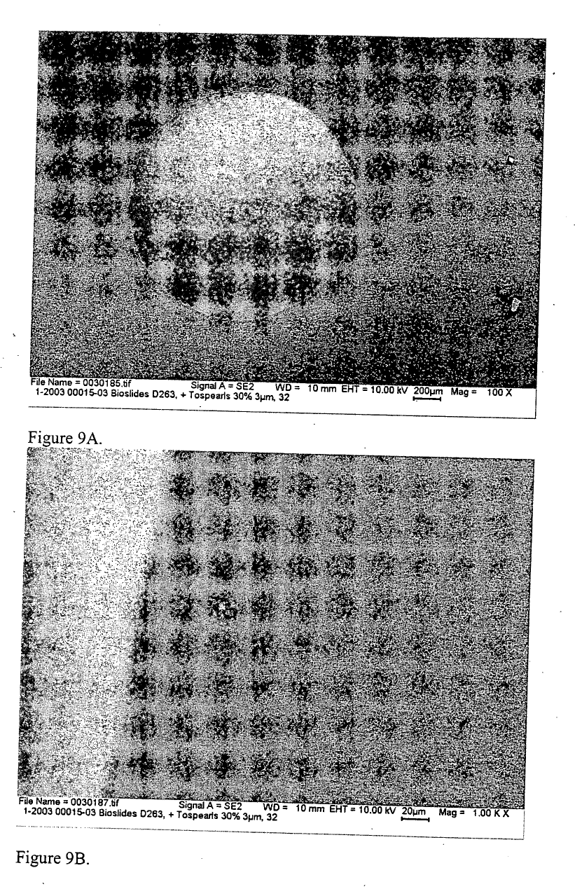

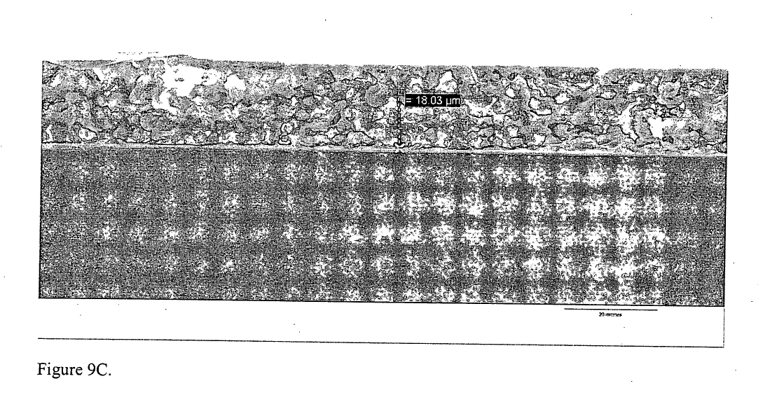

FIGS. 9A to 9D depict patterns, which are generated by screen-printing the patterning formulation (described in Table 3) and curing for 4-16 hours at 60-230° C.

TABLE 3
Silicone 110 composition.

| Ingredient | Weight % | Component |
|---|---|---|
| PDMS, vinyldimethyl terminated (10,000 CS) | 56.86 | Base |
| PDMS, vinyldimethyl terminated (65,000 CS) | 10.03 | |
| Tospearl ® 105 or 120 or 130 | 30.05 | Filler |
| Carbon black | 1.03 | Colorant |
| Methylhydrosiloxane dimethylsiloxane | 2.00 | Crosslinker |
| copolymer | | |
| 1,3,5,7-tetravinyl-1,3,5,7- | 0.02 | Moderator |
| tetramethylcyclotetrasiloxane | | |
| Platinum divinyltetramethyldisiloxane complex | 0.01 | Catalyst |

Silicone 110 is a two-part vinyl silicone hydrosilylation platinum catalyzed formulation, prepared by sequential mixing of the components in Table 3 to an initial viscosity of 150,000 CS. Workability of this particular formulation is >140 minutes. After screen-printing, the slides are cured in a convection oven at 230° C. for 19 hours. Contact angle measurements from this experiment indicated a pattern contact angle of about 110°.

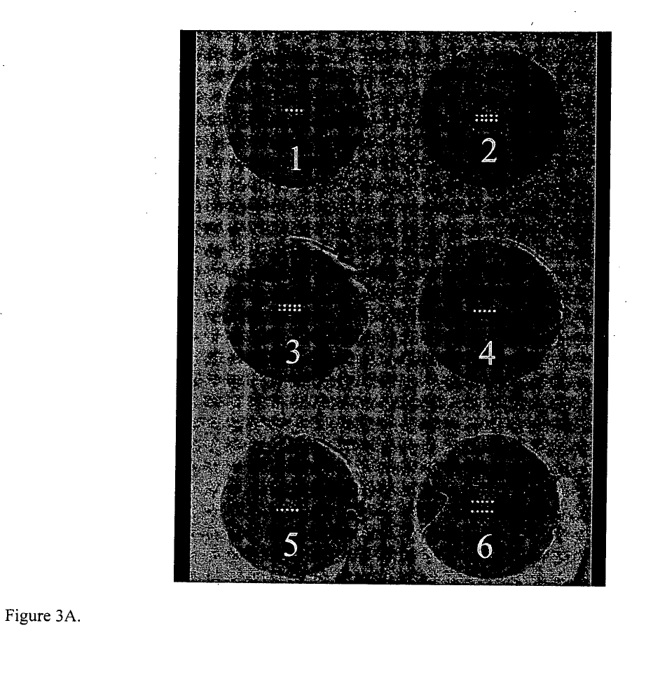

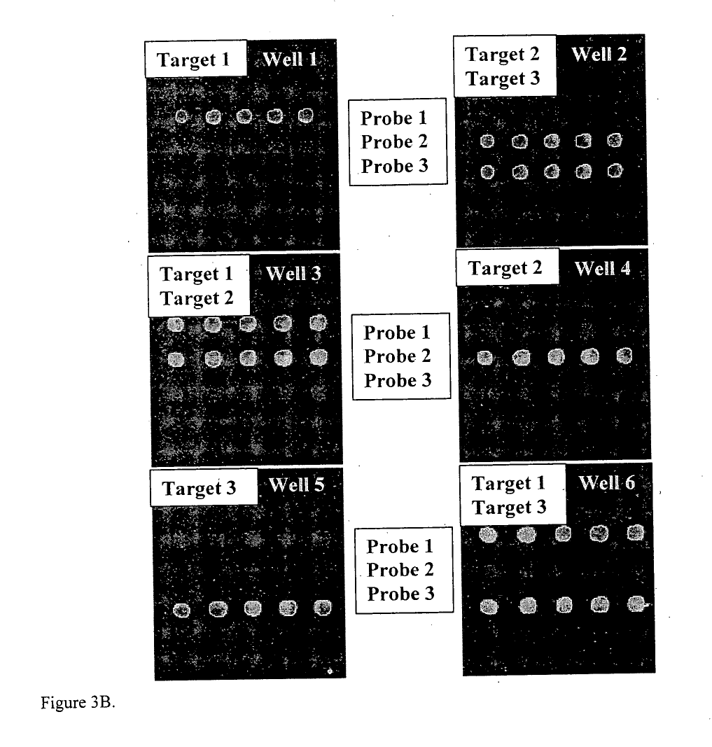

FIGS. 9A-9C shows the pattern and well quality of Silicone 110 with the filler Tospearl®. From SEM and EDX measurements the Tospearl® particles are imbedded into the pattern and thus cause no increase in the surface roughness. This is verified by contact angle measurements that show no increase between formulations that have the added Tospearl® and those that do not. FIG. 9A shows an SEM picture, of a representative good morphology, uncontaminated well on a multi-well patterned substrate. FIG. 3B shows an SEM image of the pattern-to-well transition area, having a thickness of ˜20 μm. FIG. 3C shows an SEM image of the pattern thickness uniformity, which is 18±2 μm.

### Example IV

### Silicone 130 Formulation

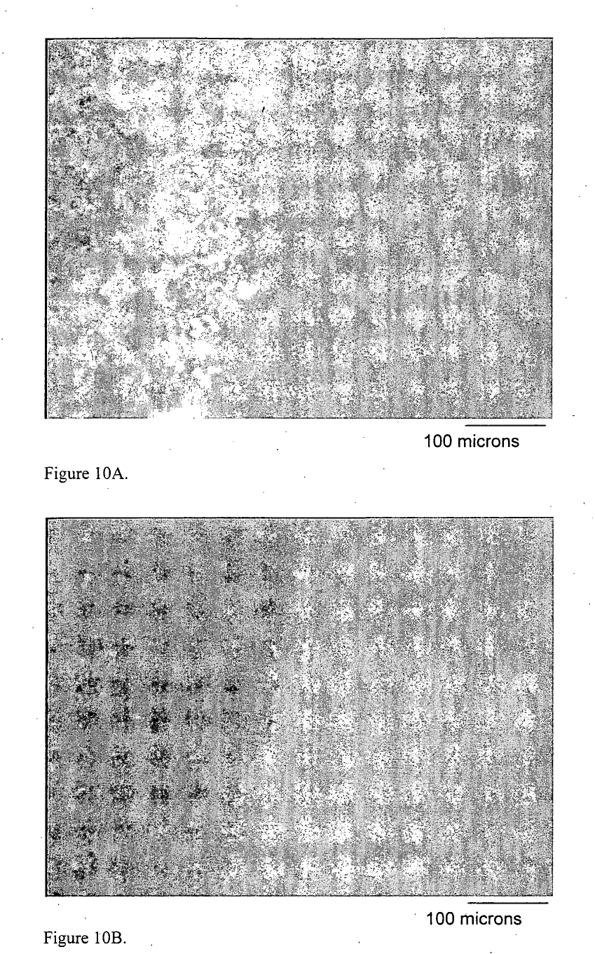

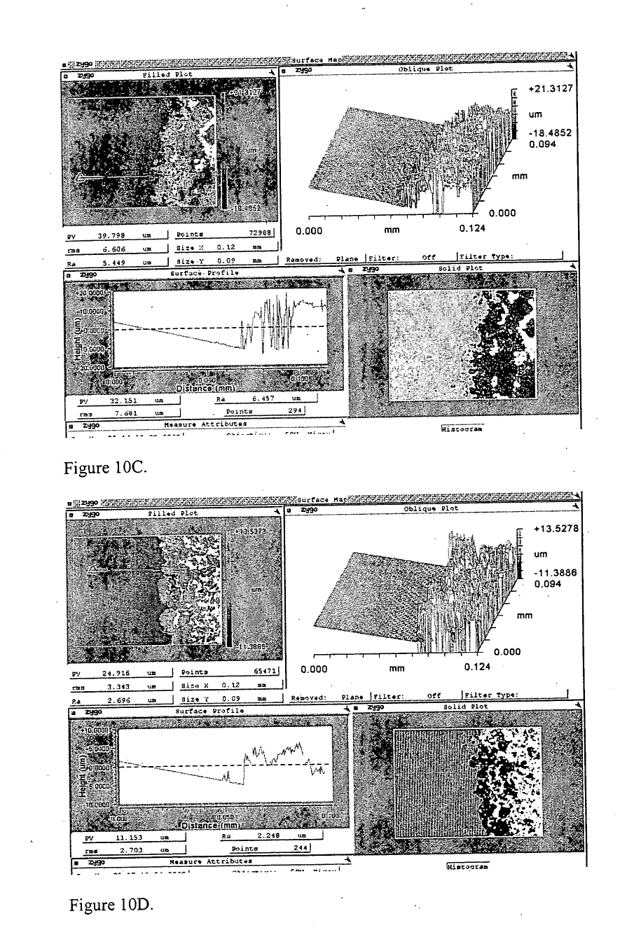

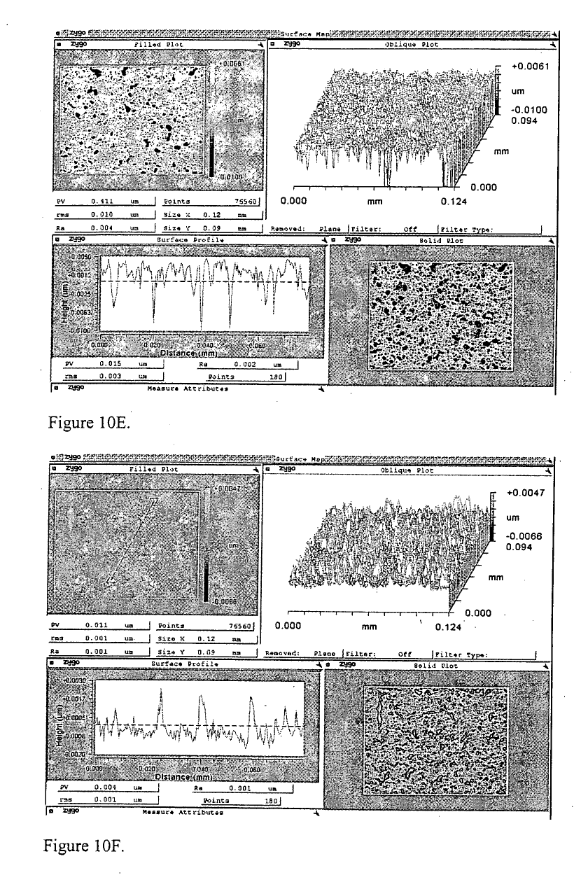

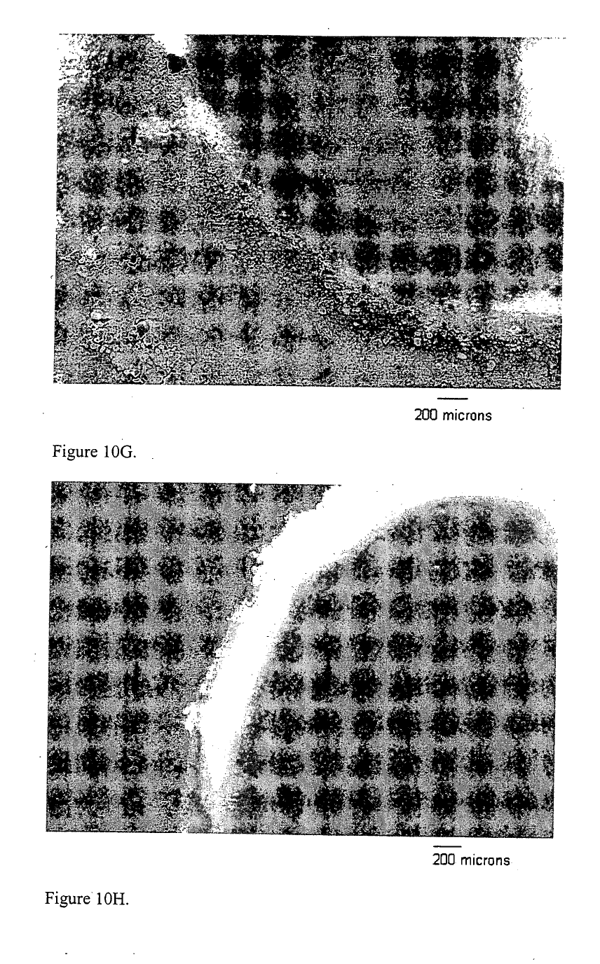

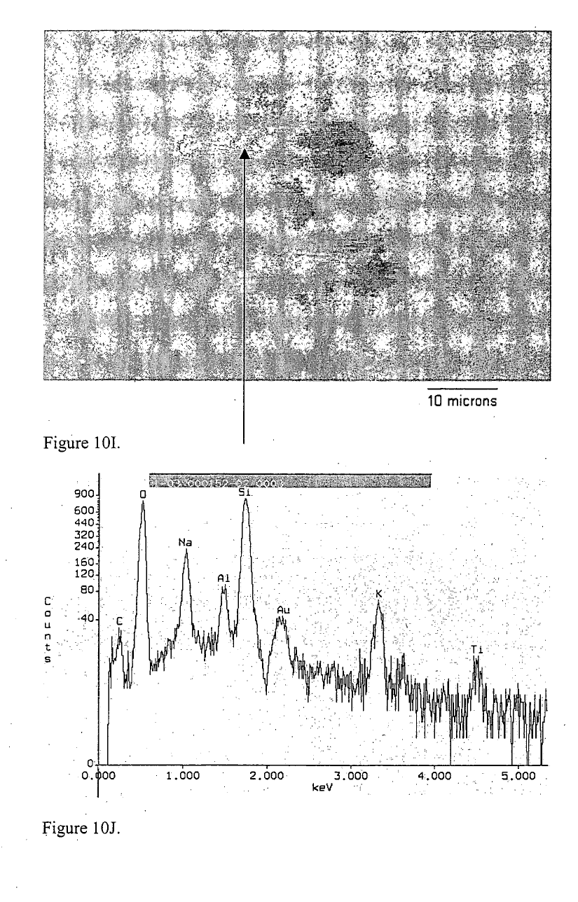

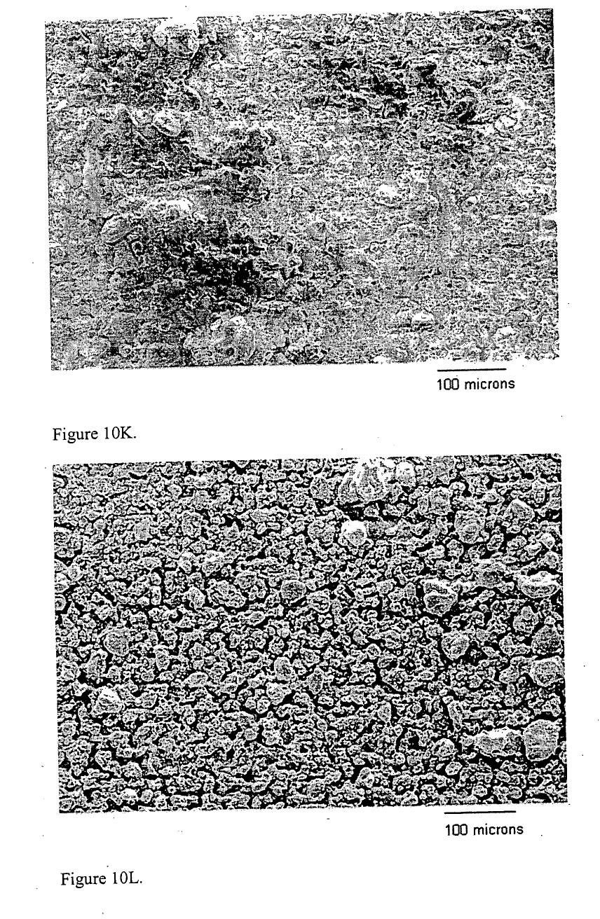

The patterns depicted in FIGS. 10A-10L are generated by screen-printing the formulation (described in Table 4) and curing for 14-19 hours at 230° C. This silicone formulation is labeled as Silicone-130 due to the pattern having a contact angle of 120-140°.

TABLE 4
Silicone 130 composition.

| Ingredient | Weight % | Component |
|---|---|---|
| PDMS, vinyldimethyl terminated (10,000 CS) | 56.84 | Base |
| PDMS, vinyldimethyl terminated (65,000 CS) | 10.03 | |
| Tospearl ® 105 | 30.06 | Filler |
| Carbon black | 1.03 | Colorant |
| Methylhydrosiloxane dimethylsiloxane | 2.00 | Crosslinker |
| copolymer | | |
| 1,3,5,7-tetravinyl-1,3,5,7- | 0.03 | Moderator |
| tetramethylcyclotetrasiloxane | | |
| Platinum divinyltetramethyldisiloxane complex | 0.01 | Catalyst |
| Tullanox ® 500 (applied after patterning) | 0.01-3.00 | Surface |
| | | Roughener |

Silicone 130 is a two-part vinyl silicone hydrosilylation platinum catalyzed formulation, prepared by sequential mixing of the components in Table 4 to an initial viscosity of 50,000-60,000 CS. Workability of this particular formulation is <90 minutes. After screen-printing, the slides are cured in a convection oven at 230° C. for 14-19 hours. Contact angle measurements from this experiment indicated a pattern contact angle of 120-140° and a well contact angle of 50-75° (the well contact angle can be significantly reduced by subsequent cleaning processes to <20°).

The patterned substrates that are obtained from these experiments have uniform pattern quality across the surface of the substrate. In these experiments Tullanox® 500 is added to the pattern after screen-printing but before curing. Due to the application of Tullanox® 500, a cleaning procedure after curing is desirable to clean the wells for further applications where an additional coating is applied. The cleaning procedure for these patterned substrates consists of brief exposure to a dilute hydrofluoric acid solution followed by several water washes and drying. Tullanox® 500 is fumed silica with an effective particle size of 0.2 μm, theoretical surface area of 325 m²/g, bulk density of 3 lbs/ft³, specific gravity of 2.2, and a reflective index of 1.46 according to the manufacturer specifications. Paired data discussed below is for patterned substrates before and after the cleaning procedure. FIGS. 10A-B are representative LM images of the pattern-to-well transition region, showing a decrease of the well-to-pattern transition border to ≈20 μm after cleaning. This is supported by white light interferrometry (WLI) measurements in FIGS. 10C-D that show a concomitant decrease of the well-to-pattern transition border thickness to ≈10 μm after cleaning. WLI measurements in FIGS. 10E-F demonstrate the relative cleanliness and smoothness of the wells. The non-cleaned well has a smooth surface {roughening (RMS) of ˜4 nm} and holes of ˜10 nm, whereas the cleaned well has a smoother surface (RMS of ˜1 nm) but seems to have ˜2.5 nm features. Before the cleaning procedure the wells are contaminated with both the silicone formulation and Tullanox® 500 particles (FIG. 10G), but after the cleaning procedure only small amounts of Tullanox® agglomerates are left (FIG. 10H-J). FIGS. 10K-L demonstrates the effect of the cleaning procedure on the pattern, showing a more defined surface after cleaning by SEM. The patterned surface has defined particles (agglomerates of Tullanox 2-60 μm), giving a roughened surface with a contact angle of 120-140°.

Examples V-VIII relate to performance improvements are achieved with silicone patterning as compared to commercially available PTFE patterning due largely to the combination of components used in the patterning formulations of the present invention.

### Example V

### Fluorescence

The minimization of background fluorescence is often important in microarray experiments, as the detection method of choice is fluorescence. The first step in minimizing background fluorescence is the use of substrates formulated specifically to reduce self-fluorescence as much as possible. With respect to glass, this is described with more detail in U.S. patent application Ser. No. 09/947,923, which is incorporated herein by reference. It is preferred to have as low a fluorescent patterned substrate as possible to aid in the detection of weak fluorescent signals. Self-fluorescence in the patterning material can cause scanner saturation (high fluorescence) and addition of noise to the experiment, particularly troublesome for probe/targets located near the well-to-pattern.

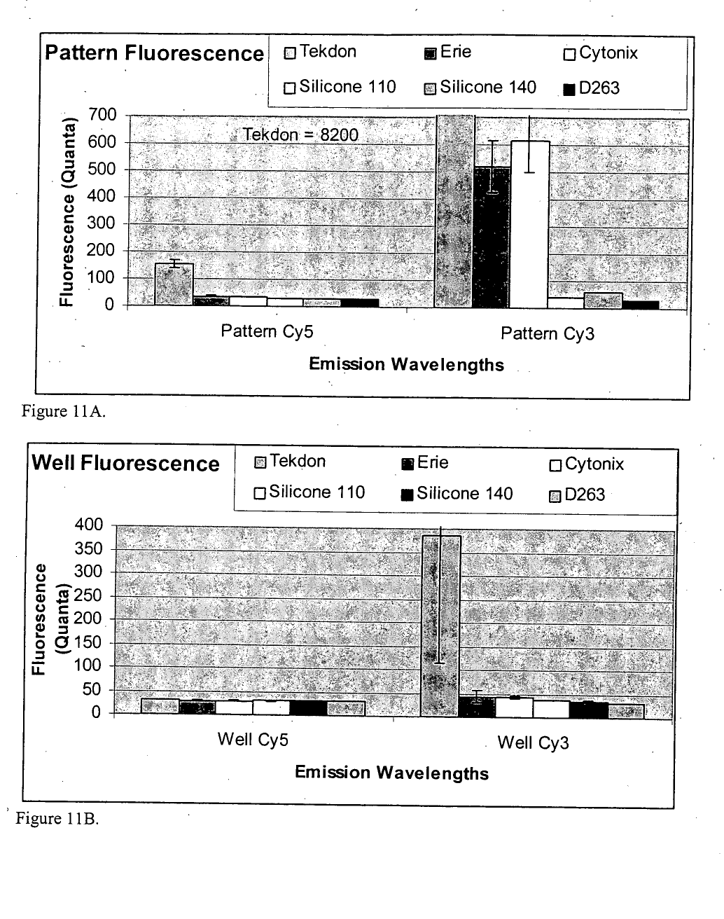

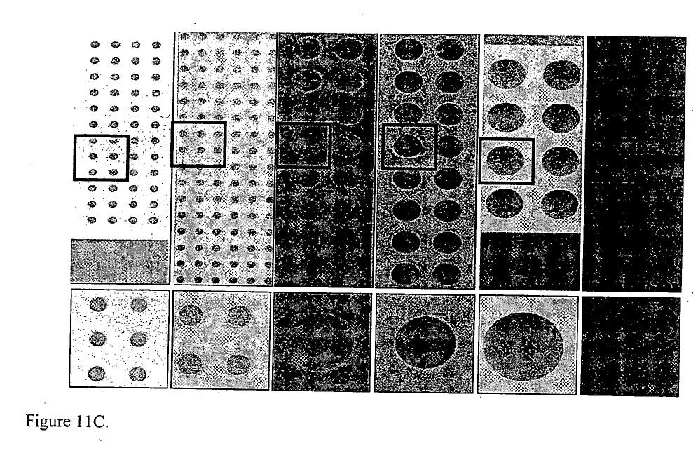

The fluorescent signals for PTFE based patterned glass slides from Tekdon, Erie, commercially available PTFE hydrophobic ink from Cytonix patterned in-house, Silicone 110, and Silicone 140 are compared with that from a low self-fluorescent Schott glass substrate (borosilicate glass 3). Commercially available PTFE-based slides from Tekdon and Erie are characterized for fluorescence in the as received state, while substrates are patterned with the Cytonix and Silicone patterning materials in-house prior to characterization. All data is obtained under identical scanning conditions (Axon 4000B scanner; 10 μm/pixel resolution; 100% laser power; 400 V PMT; Cy5 and Cy3 fluorescent dye excitation/emission conditions). The data shown in FIGS. 11A-C are the averages obtained from a minimum of three patterned substrates. FIG. 11A shows the fluorescent comparison of the patterning material while FIG. 11B shows the fluorescent comparison of the wells. The pattern and well fluorescence under Cy5 and Cy3 conditions are ranked from highest to lowest as a ratio to Schott borosilicate glass 3: Cy5 pattern Tekdon (5.1)>Erie & Cytonix (1.2)>Silicone 110 & Silicone 140 (1.1); Cy 3 pattern Tekdon (258.3)>Cytonix (19.3)>Erie (16.3)>Silicone 140 (1.9)>Silicone 110 (1.2); Cy5 wells Tekdon (1.1)>Erie/Cytonix/Silicone 110/Silicone 140 (1.0); Cy3 wells Tekdon (12.0)>Erie & Cytonix (1.3)>Silicone 110 (1.2) and Silicone 140 (1.1). The data clearly show the decrease in pattern fluorescence in going from a PTFE or perfluorinated patterning formulation to a silicone based patterning formulation with drastic reduction observed under Cy3 conditions. FIG. 11C contains fluorescent images for the various patterned substrates. The absence of color means low fluorescence; white means the detector is saturated by signal (Tekdon). Boxed areas are enlarged for clarity. The images are displayed as the ratio of Cy3/Cy5. Variation of the PMT voltage will cause an increase or decrease of the pattern fluorescence.

### Example VI

### Chemical Durability

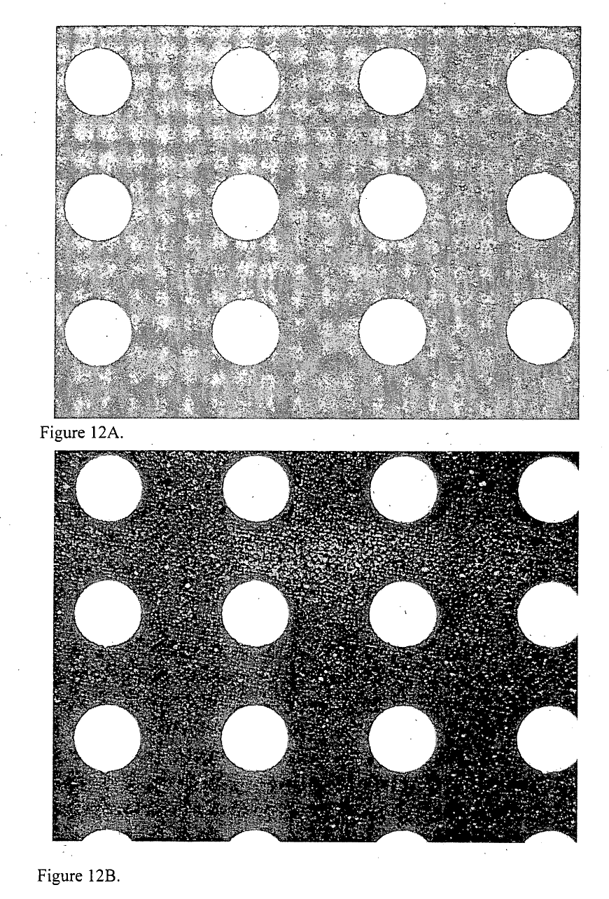

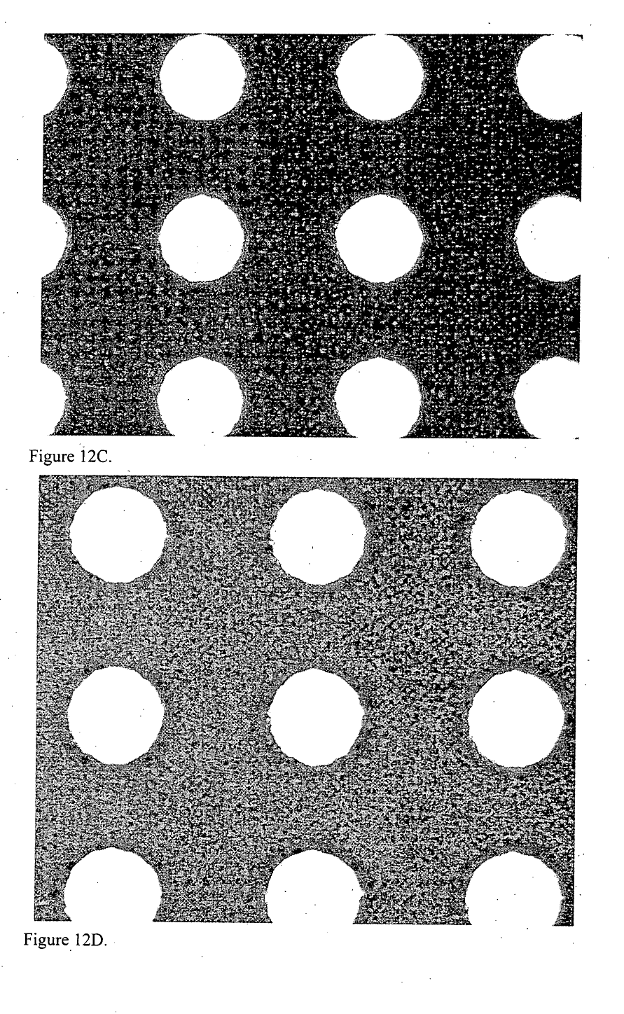

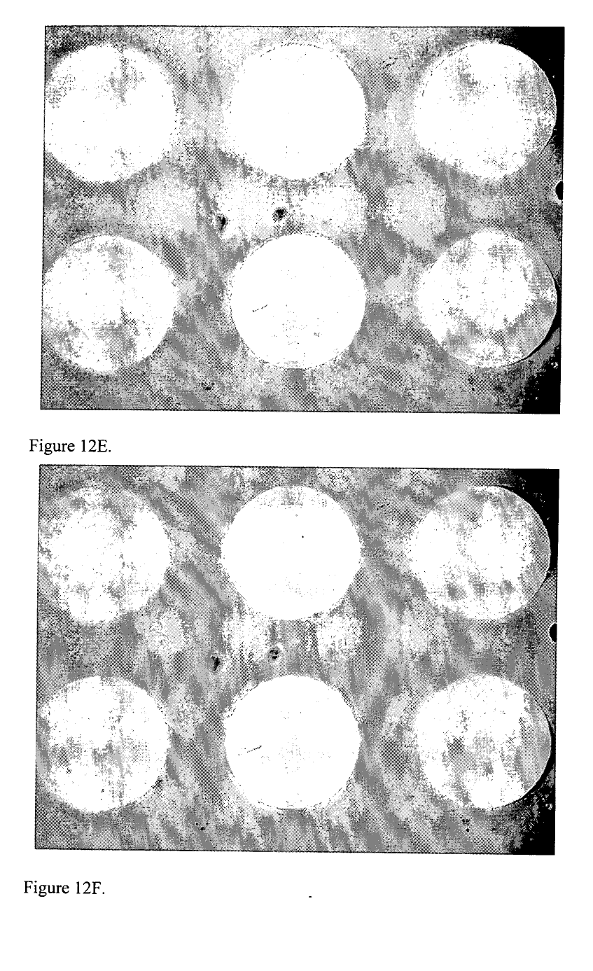

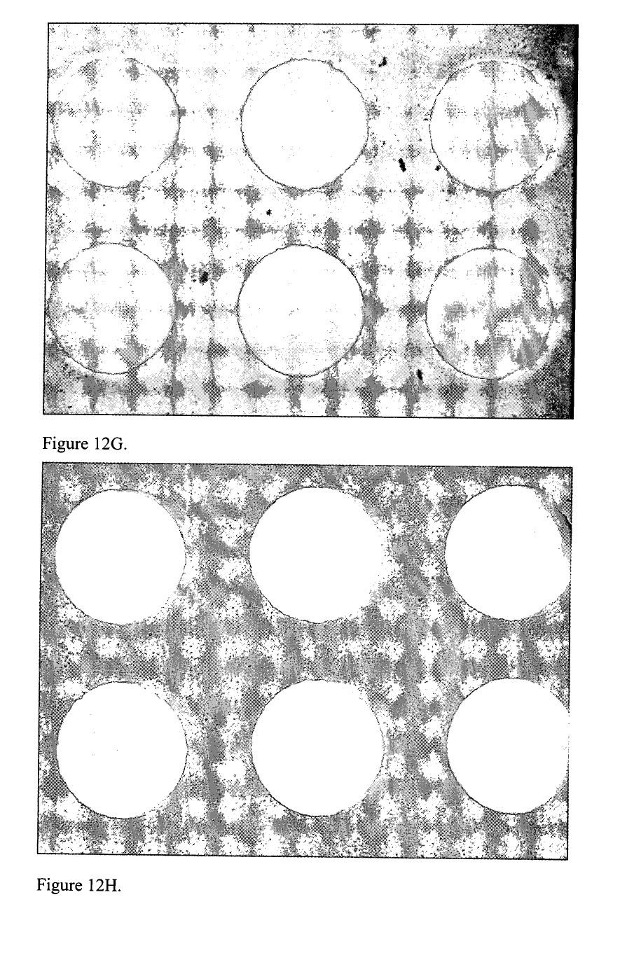

Improved chemical durability of the patterning material, especially to acid and base conditions, allow both a wider range of applications (solutions that can be applied to the patterned substrate without degradation of the pattern) and improved ability to provide clean, wettable wells for further applications such as providing a coated, patterned substrate. Table 5 (weight loss data) clearly shows that the chemical durability of perfluorinated patterns is substantially less when exposed to various cleaning solutions. The chemical durability of commercially available PTFE-based patterned substrates from Erie Scientific & Tekdon, along with commercially available PTFE-based ink from Cytonix Corporation, are compared with that of Silicone 110 and Silicone 140 patterned substrates using a cleaning protocol intended to test chemical durability over the wide range of conditions that patterns might be subjected to during coating processes and biological assays. The cleaning protocol consists of dipping steps 5-15 minutes duration, with or without ultrasonication, temperature ranges 20-90° C., with 1-3 water steps in-between, using detergent based (Micro90, Cole Parmer), NaOH (pH >12; temperature 20-90° C.), and HCl (pH >3) solutions. The perfluorinated/teflon patterns are observed to weaken (pattern coming off in solution; increased number of pinholes/bare areas on glass) with the use of ultrasonics. The pattern from Tekdon failed to survive this cleaning procedure, and is entirely removed from the glass during the NaOH step. FIGS. 12A-12B demonstrate the effects of cleaning on Erie Scientific pattern, namely an increase in pinholes (bare spots on glass within patterned area). FIGS. 12C-12D demonstrate the effects of cleaning on Cytonic perfluorinated ink pattern, showing even more pinholes than Erie. FIGS. 12E-F and FIGS. 12G-H demonstrate the effects of cleaning on Silicone 110 and Silicone 140, respectively. The silicone patterned substrates do not exhibit significant degradation after being subjected to the cleaning process described above. Table 5 contains the weight loss data measured for the four slide types that survived the cleaning process. Each datapoint in Table 5 is obtained by averaging the results from 3 slides. Silicone 110 and Silicone 140 are clearly superior in terms of visual integrity of pattern (least # of pinholes) and weight loss after cleaning.

TABLE 5
Weight loss data after the cleaning of patterned substrates.

| | Tekdon | Erie | Cytonix | Silicone | Silicone |
|---|---|---|---|---|---|
| | (PTFE) | (PTFE) | (PTFE) | 110 | 140 |
| Weight loss (%) after | 100 | 0.042 | 0.114 | 0.021 | 0.035 |
| cleaning | | | | | |
| Weight loss normalized | 4762 | 2 | 5.43 | 1 | 1.67 |
| to Silicone 110 | | | | | |

Cytonix, Silicone 110, and Silicone 140 slides are additionally subjected to chemical durability testing using selected relevant biological solutions. There are no significant pattern degradation or weight loss effects caused by exposure to typical microarraying solutions containing 50 mM ethanolamine/50 mM borate (4 hours), phosphate buffer solution/0.5 % tween (a detergent—40 minutes), phosphate buffer solution/1% bovine serum albumin (1 hour), and HEPES (4 hours) for any of the patterned substrates tested.

### Example VII

### Pattern Thickness Uniformity

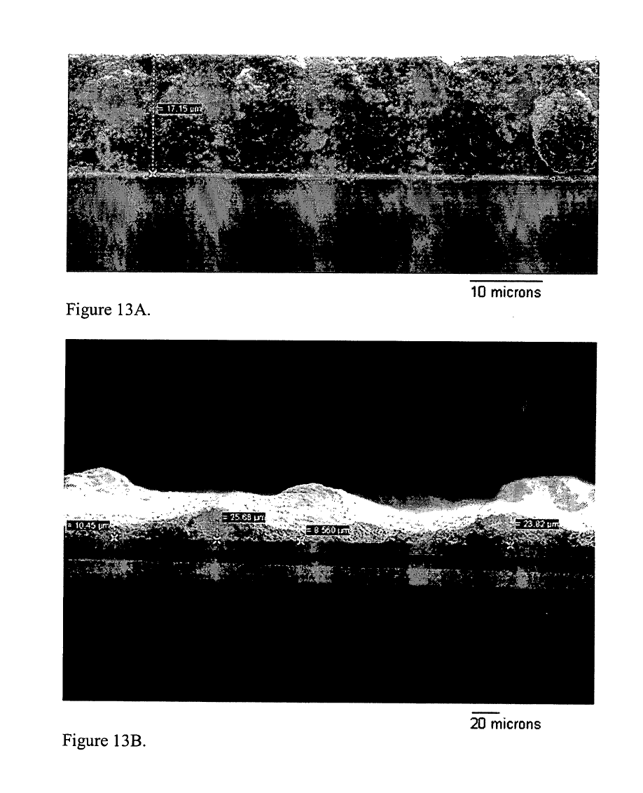

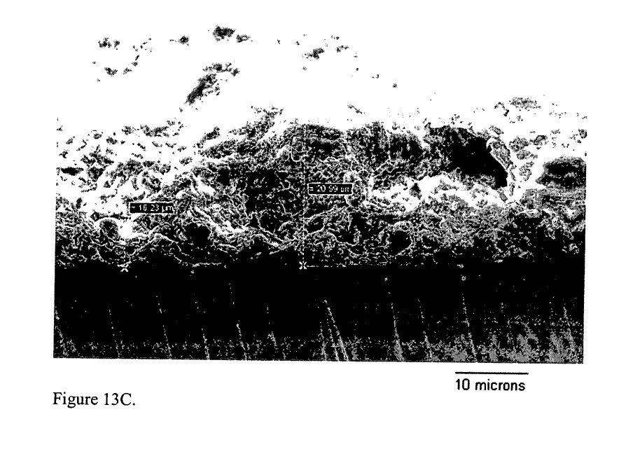

A uniformly thick patterned substrate should result in tighter fitting and better sealing coverslips, cover glasses, lids, capping devices, etc., when such items are used during a hybridization assay. Thus, in many situations, the pattern thickness uniformity may be an important criterion for microarraying, assaying, and biomolecule recognition experiments. Specifically, after probes are spotted into the separate wells of the patterned substrate, individual target-containing solutions must then be delivered to individual wells to initiate a hybridization or biomolecule interaction. This involves the simultaneous or near-simultaneous delivery of liquid target-containing solutions to the individual wells on a patterned substrate, followed by incubation for up to several hours at temperatures ranging from 25-70° C. To prevent evaporation of the target-containing solution during incubation, capping devices such as coverslips or lids are often used. A better seal can likely be formed between the coverslip device and the patterned surface, if the surface is highly uniform. FIG. 13A demonstrates the uniformity of Silicone 110, FIG. 13B demonstrates the decreased uniformity of a representative commercially available PTFE-based pattern from Erie Scientific, while FIG. 13C demonstrates the decreased uniformity obtained from the commercially available Cytonix formulation (Perfluoro™ MH1000 Black). These hydrophobic patterns are all deposited by screen-printing methodology. See Table 1 for the observed thickness ranges of the aforementioned patterns.

### Example VIII

### Hydrophobicity

The ability to customize patterned substrates with a hydrophobicity range of 110-155° extends the application usage, allowing accommodation of different biological solutions that interact with the surface differently (e.g., a microarray solution that contains no organic solvents or surfactants will interact differently with a surface than a solution containing an organic solvent such as DMSO or a surfactant such as TWEEN). Further, it is advantageous to be able to control the drop size (volume) and shape of biological solutions confined in the wells by the interaction with the boundary hydrophobic patterning material. Additionally, the hydrophobicity of the patterned substrate often plays an important function in maintaining separation of aqueous based solutions in the well area of the patterned substrate. FIGS. 8A-8B show the contact angle images of two exemplary formulations (Silicone 110 and Silicone 140), demonstrating the range of hydrophobicity that can be introduced through the introduction of surface roughening agents.

The entire disclosure of all applications, patents and publications, cited above or below, is hereby incorporated by reference. The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A surface for attachment of molecules comprising:
(a) a substrate;
(b) a patterned hydrophobic crosslinked silicone-containing coating on said substrate and;
c) a coating on said substrate of a chemically functional compound to which other molecules are chemically bondable.

2. A surface of claim 1, wherein said substrate is low self-fluorescent.

3. A surface according to claim 2, wherein the substrate is a low self-fluorescent glass.

4. A surface according to claim 3, wherein the glass is borosilicate or soda-lime silicate glass.

5. A surface according to claim 2, wherein the hydrophobic silicone-containing coating is low self-fluorescent.

6. A surface according to claim 1, wherein the silicone-containing coating comprises
a crosslinkable silicone,
a particle filler,
a crosslinking agent,
and a catalyst.

7. A surface according to claim 6, wherein the silicone-containing coating comprises
20-80% of a crosslinkable silicone and
5-50% of a particle filler.

8. A surface according to claim 6, wherein the silicone-containing coating further comprises a colorant, an inhibitor, or a roughening agent.

9. A surface according to claim 1, wherein the chemically functional compound is an organosilane, an alkanethiol, or a hydrogel.

10. A surface according to claim 9, wherein the organosilane is aminopropyltrimethoxysilane (APS), N-(2-aminoethyl)-3-aminopropyltrimethoxysilane (EDA), trimethoxysilylpropyldiethylenetriamine (DETA), (aminoethyl aminomethyl)phenethyltrimethoxysilane (PEDA), dimethoxysilyl-propyldiethylenetriamine, N-(2-aminoethyl)-3-aminopropyylmethyldimethoxy-silane, N-(6-aminohexyl)aminopropyltrimethoxysilane (AHA), 4-aminobutyltri-ethoxysilane, N-(2-aminoethyl)-3-aminoisobutylmethyldi-methoxysilane or mixtures thereof.

11. A surface according to claim 9, wherein the organosilane is 2-(3,4-epoxycyclohexyl) ethyltrimethoxysilane, (3-glycidoxypropyl)trimethoxy-silane, (3-glycidoxy propyl)dimethyloxysilane, (3-glycidoxy propyl)methyldiethy-oxysilane, (3-glycidoxy propyl)methyldimethoxysilane, 2-(3,4-epoxycyclohexyl) ethyltriethoxysilane, 5,6-epoxyhexyltriethoxysilane or mixtures thereof.

12. A surface according to claim 6, wherein the crosslinkable silicone is a vinyl terminated silicone.

13. A surface according to claim 6, wherein the crosslinkable silicone is a polysiloxane having at least one reactive functional group.

14. A surface according to claim 13, wherein said reactive functional group is amino, epoxy, carbinol, methacrylate, acrylate, mercapto, carboxylate, anhydride, alkoxy, amine, oxime, enoxy, or acetoxy.

15. A surface according to claim 6, wherein the silicone compound has two reactive functional groups.

16. A surface according to claim 6, wherein the crosslinkable silicone is a polydialkylsiloxane.

17. A surface according to claim 6, where more than one crosslinkable silicone is used in the coating.

18. An array of immobilized biomolecules comprising a plurality of biomolecules attached to a surface according to claim 1.

19. An array of immobilized nucleic acid molecules comprising a plurality of nucleic acid molecules attached to a surface according to claim 1.

20. A surface according to claim 1, wherein said patterned hydrophobic crosslinked silicone-containing coating creates distinct hydrophobic “boundary” and hydrophilic “well” areas of different free surface energies differing by about >10 dynes/cm.

21. A surface according to claim 1, wherein the hydrophobic silicone-containing pattern contributes <50% of the total self-fluorescence.

22. A substrate according to claim 1, wherein said hydrophobic crosslinked silicone pattern is 1 to 100 μm thick.

23. A substrate according to claim 22, wherein said hydrophobic crosslinked silicone pattern is 1 to 30 μm thick.

24. A substrate according to claim 1, wherein said hydrophobic silicone-containing has a H₂O contact angle of 100 to 160°.

25. A substrate according to claim 1, wherein the hydrophobic silicone-containing pattern is applied to the substrate by screen-printing.

26. An array according to claim 18, wherein said chemically functional compound is an organosilane, alkanethiol, or hydrogel.

27. A surface according to claim 6, wherein said particle filler is a fumed silica.

28. A surface according to claim 3, wherein said glass comprises, in % by weight on an oxide basis:

| | |
|---|---|
| SiO₂ | 58-85 |
| B₂O₃ | 7-15 |
| Al₂O₃ | 0-8 |
| Na₂O | 0-15 |
| K₂O | 0-8 |
| ZnO | 0-8 |
| CaO | 0-8 |
| MgO | 0-8 |
| As₂O₃ | 0-2 |
| Sb₂O₃ | 0-2. |

29. A surface according to claim 3, wherein said glass comprises, in % by weight on an oxide basis:

| | |
|---|---|
| SiO₂ | 40-60 |
| B₂O₃ | 10-20 |
| Al₂O₃ | 8-20 |
| BaO | 20-30 |
| Na₂O | 0-5 |
| K₂O | 0-5 |
| ZnO | 0-7 |
| CaO | 0-8 |
| MgO | 0-5 |
| As₂O₃ | 0-2 |
| Sb₂O₃ | 0-2. |

30. A surface according to claim 3, wherein said glass comprises, in % by weight on an oxide basis:

| | |
|---|---|
| SiO₂ | 60-70 |
| B₂O₃ | 5-10 |
| Al₂O₃ | 0.1-8 |
| Na₂O | 0-8 |
| K₂O | 0-8 |
| ZnO | 3-10 |
| TiO₂ | 1-10 |
| CaO | 0-5 |
| MgO | 0-5 |
| As₂O₃ | 0-2 |
| Sb₂O₃ | 0-2. |

31. A surface according to claim 3, wherein said glass comprises, in % by weight on an oxide basis:

| | |
|---|---|
| SiO₂ | 65-75 |
| Na₂O | 5-15 |
| K₂O | 5-15 |
| ZnO | 2-6 |
| TiO₂ | 0.1-5 |
| BaO | 0.1-5 |
| CaO | 0-10 |
| MgO | 0-6 |
| PbO | 0-3 |
| Al₂O₃ | 0-3 |
| B₂O₃ | 0-5 |
| As₂O₃ | 0-2 |
| Sb₂O₃ | 0-2. |

32. An array of immobilized molecules comprising a plurality of carbohydrate, protein, nucleic acid, small molecules, or cells attached to a surface according to claim 1.

33. A surface according to claim 1, further comprising an edge marking on a second surface of the substrate.

34. A surface according to claim 1, wherein the thickness of said patterned hydrophobic silicone-containing coating has a deviation of less than +/−20%.

35. A method of preparing a hydrophobic patterned substrate useful for the attachment of biomolecules comprising:
a) applying to a substrate a pattern of a silicone-containing composition comprising a crosslinkable silicone, a crosslinking agent, a filler, and a catalyst; and
b) curing the patterned silicone composition.

36. A method according to claim 35, further comprising
applying a coating of a chemically functional compound to which other molecules are chemically bondable.

37. The method of claim 35, wherein the silicone composition further comprises a colorant, a roughening agent or an inhibitor.

38. The method of claim 35, wherein the silicone composition comprises
20-80% of a crosslinkable silicone and
5-50% of a particle filler.

39. The method of claim 37, wherein the silicone composition further comprises 0.1-5% of a colorant.

40. The method of claim 37, wherein the silicone composition further comprises 0.0001-3% of an inhibitor.

41. The method of claim 37, wherein said roughening agent is applied to the patterned silicon composition prior to curing.

42. The method of claim 41, wherein said roughening agent is applied by dipping or spraying.

43. The method of claim 35, wherein the patterned silicone composition is applied to the substrate by screen-printing or silk-screening.

44. The method of claim 35, wherein the curing process is a thermal curing process or an electromagnetic radiation induced curing process.

45. The method of claim 44, wherein the thickness of the patterned silicone composition is from 1 to 100 μm.

46. The method of claim 45, wherein the thickness of the patterned silicone composition is from 1 to 30 μm.

47. The method of claim 35, wherein said substrate is low self-fluorescent.

48. The method of claim 47, wherein the substrate is a low self-fluorescent glass.

49. The method of claim 48, wherein the glass is borosilicate or soda-lime silicate glass.

50. A method according to claim 36, wherein the chemically functional compound is an organosilane, alkanethiol, or hydrogel.

51. A method according to claim 36, wherein the chemically functional compound is aminopropyltrimethoxysilane (APS), N-(2-aminoethyl)-3-aminopropyltri-methoxysilane (EDA), trimethoxysilylpropyldiethylenetriamine (DETA), (aminoethyl aminomethyl)phenethyltrimethoxysilane (PEDA), dimethoxysilyl-propyldiethylenetriamine, N-(2-aminoethyl)-3-aminopropyylmethyldimethoxy-silane, N-(6-aminohexyl) aminopropyltrimethoxysilane (AHA), 4-aminobutyltri-ethoxysilane, or N-(2-aminoethyl)-3-aminoisobutylmethyldi-methoxysilane, epoxysilane is 2-(3,4-epoxycyclohexyl) ethyltrimethoxysilane, (3-glycidoxypropyl)trimethoxysilane, (3-glycidoxy propyl)dimethyloxysilane, (3-glycidoxy propyl)methyldiethyoxysilane, (3-glycidoxy propyl)methyldimethoxysilane, 2-(3,4-epoxycyclohexyl) ethyltriethoxysilane, 5,6-epoxyhexyltriethoxysilane, or a mixture thereof.

52. A method according to claim 35, wherein the patterned silicone composition is low fluorescent.

53. A method according to claim 35, wherein an edge marking of a second surface of the substrate is performed.

54. A surface for attachment of molecules comprising:
(a) a low self-fluorescent substrate; and
(b) a patterned hydrophobic cross-linked silicone containing coating on said substrate

55. A surface according to claim 54, wherein the low self-fluorescent substrate is glass.

56. A surface according to claim 55, wherein the glass is borosilicate or soda-lime silicate glass.

57. A surface according to claim 54, wherein the hydrophobic silicone-containing coating is low self-fluorescent.

58. A surface according to claim 54, wherein the silicone-containing coating comprises
a crosslinkable silicone,
a particle filler,
a crosslinking agent,
and
a catalyst.

59. A surface according to claim 58, wherein the silicone containing coating comprises
20-80% of a crosslinkable silicone.
5-50% of a particle filler.

60. A surface according to claim 58, wherein the silicone containing coating further comprises a colorant, an inhibitor, or a roughening agent.

61. A surface according to claim 54, further comprising a coating of a chemically functional compound to which other molecules are chemically bondable.

62. A surface according to claim 61, wherein the chemically functional compound is an organosilane, an alkanethiol, or a hydrogel.

63. A surface according to claim 62, wherein the organosilane is aminopropyltrimethoxysilane (APS), N-(2-aminoethyl)-3-aminopropyltri-methoxysilane (EDA), trimethoxysilylpropyldiethylenetriamine (DETA), (aminoethyl aminomethyl)phenethyltrimethoxysilane (PEDA), dimethoxysilyl-propyldiethylenetriamine, N-(2-aminoethyl)-3-aminopropyylmethyldimethoxy-silane, N-(6-aminohexyl)aminopropyltrimethoxysilane (AHA), 4-aminobutyltri-ethoxysilane, N-(2-aminoethyl)-3-aminoisobutylmethyldi-methoxysilane, 2-(3,4-epoxycyclohexyl) ethyltrimethoxysilane, (3-glycidoxypropyl)trimethoxy-silane, (3-glycidoxy propyl)dimethyloxysilane, (3-glycidoxy propyl)methyldiethy-oxysilane, (3-glycidoxy propyl)methyldimethoxysilane, 2-(3,4-epoxycyclohexyl) ethyltriethoxysilane, 5,6-epoxyhexyltriethoxysilane or a mixture thereof.

64. A surface according to claim 54, wherein the crosslinkable silicone is a vinyl terminated silicone or a polysiloxane having at least one reactive functional group.

65. A surface according to claim 64, wherein the reactive functional group is amino, epoxy, carbinol, methacrylate, acrylate, mercapto, carboxylate, anhydride, alkoxy, amine, oxime, enoxy, or acetoxy.

66. A surface according to claim 54, wherein the silicone compound has two reactive functional groups.

67. A surface according to claim 54, wherein the crosslinkable silicone is a polydialkylsiloxane.

68. A surface according to claim 54, wherein more than one crosslinkable silicone is used in the coating.

69. An array of immobilized biomolecules comprising a plurality of biomolecules attached to a surface according to claim 54.

70. A surface according to claim 54, wherein the pattern creates distinct hydrophobic “boundary” and hydrophilic “well” areas of different free surface energies differing by about >10 dynes/cm.

71. A surface according to claim 54, wherein the hydrophobic silicone-containing pattern contributes <50% of the total self-fluorescence.

72. A substrate according to claim 54, wherein said hydrophobic crosslinked silicone pattern is from 1 to 30 μm thick.

73. A substrate according to claim 54, wherein said hydrophobic silicone-containing pattern has a thickness deviation of less than +/−20%.

74. A substrate according to claim 54, wherein said hydrophobic silicone-containing pattern has a H₂O contact angle of 100 to 160°.

75. A substrate according to claim 54, wherein the hydrophobic silicone-containing pattern is applied to the substrate by screen-printing.
